(19) United States
(12) Patent Application Publication
(10) Pub. No.: US 2005/0225626 A1
(43) Pub. Date: Oct. 13, 2005

(54) Printing method, medium detection method, computer-readable storage medium, and printing apparatus

(75) Inventors: Hitoshi Igarashi, Nagano-ken (JP); Koji Niioka, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/094,846

(22) Filed: Mar. 31, 2005

(30) Foreign Application Priority Data
Mar. 31, 2004 (JP) 2004-105570
Mar. 31, 2004 (JP) 2004-105571
Feb. 15, 2005 (JP) 2005-038397
Feb. 15, 2005 (JP) 2005-038398

(51) Int. Cl. B41J 2/01

(52) U.S. Cl. 347/234

(57) ABSTRACT

A printing method includes the steps of: emitting light from a light-emitting section of an optical sensor toward a support member for supporting a medium, the support member being provided with an ink collecting section for collecting ink that has been ejected from an ink ejecting section and that has landed outside of the medium; changing a threshold value based on a signal that is output from the optical sensor in correspondence with an intensity of light reflected by the support member and received by a light-receiving section of the optical sensor; and detecting the medium by comparing the signal that is output from the optical sensor and the threshold value that has been changed.

### CROSS-REFERENCE TO RELATED APPLICATIONS

The present application claims priority upon Japanese Patent Application No. 2004-105570 filed on Mar. 31, 2004, Japanese Patent Application No. 2004-105571 filed on Mar. 31, 2004, Japanese Patent Application No. 2005-038397 filed on Feb. 15, 2005, and Japanese Patent Application No. 2005-038398 filed on Feb. 15, 2005, which are herein incorporated by reference.

### BACKGROUND OF THE INVENTION

1. Field of the Invention

The present invention relates to printing methods, medium detection methods, computer-readable storage media, and printing apparatuses.

2. Description of the Related Art

Inkjet printers are known as one example of printing apparatuses that print images by forming dots on various types of media, including paper, cloth, and film. Inkjet printers perform printing by ejecting inks of various colors such as cyan (C), magenta (M), yellow (Y), and black (K) toward a medium, forming dots on the medium through the ejected ink.

In recent years, such inkjet printers have come to perform a type of printing known as “borderless printing” (see, for example, JP 10-52967A, JP 63-118824A, and JP 10-337939A). “Borderless printing” is printing in which ink is ejected onto the edges of the medium without leaving a blank margin on the medium. There are instances in which the ink that has been ejected toward the edges of the medium lands outside of the medium. Accordingly, such printers are provided with an ink collecting section for collecting the ink that lands outside of the medium. An absorbing member such as a sponge is provided in the ink collecting section, and ink that has been collected is absorbed and held by the absorbing member.

In such printing apparatuses, however, there is the problem that ink that has been ejected from the nozzles may turn into a spray-like mist inside the printer, and this mist may dirty the platen, which supports the medium being printed. Mist is particularly prone to occur during “borderless printing” due to the ink that lands outside of the medium, and this causes noticeable dirtying of the platen.

When the platen is dirty, the medium on the platen cannot be accurately detected by a sensor or the like during printing, and this prevents the width and/or the edges of the medium from being correctly detected, causing problems such as ink being ejected to spots significantly outside of the medium or errors in size detection.

### SUMMARY OF THE INVENTION

The present invention was arrived at in light of the foregoing matters, and it is an object thereof to make it possible to detect the medium accurately even when the platen has become dirty due to mist, for example.

An aspect of the present invention is a printing method comprising the steps of: emitting light from a light-emitting section of an optical sensor toward a support member for supporting a medium, the support member being provided with an ink collecting section for collecting ink that has been ejected from an ink ejecting section and that has landed outside of the medium; changing a threshold value based on a signal that is output from the optical sensor in correspondence with an intensity of light reflected by the support member and received by a light-receiving section of the optical sensor; and detecting the medium by comparing the signal that is output from the optical sensor and the threshold value that has been changed.

Another aspect of the present invention is a printing method comprising the steps of: when inspecting a condition of a supporting section that supports a medium being printed by a printing section, changing a threshold value based on a value that is obtained by sampling, at a different period from a predetermined period, a signal that is generated by an optical sensor in correspondence with an intensity of light emitted onto the supporting section from a light-emitting section of the optical sensor and reflected by the supporting section and received by a light-receiving section of the optical sensor when the optical sensor is moved relative to the supporting section; and when performing printing, detecting the medium by comparing the threshold value that has been changed and a value that is obtained by sampling, at the predetermined period, the signal that is generated by the optical sensor when the optical sensor is moved relative to the supporting section.

Other features of the present invention will become clear through the following description and the accompanying drawings.

### BRIEF DESCRIPTION OF THE DRAWINGS

FIG. 1 is a perspective view of an embodiment of a printing apparatus;

FIG. 2 is a perspective view describing the internal structure of the printing apparatus;

FIG. 3 is a sectional view showing the carry section of the printing apparatus;

FIG. 4 is a block structural diagram showing the system configuration of the printing apparatus;

FIG. 5 is a plan view showing an example of an ink ejecting section (printing section) of the printing apparatus;

FIG. 6 is an explanatory diagram that schematically shows the structure of the linear encoder;

FIG. 7A is a timing chart showing the output waveform of the linear encoder when rotating forward, and FIG. 7B is a timing chart showing the output waveform of the linear encoder when rotating in reverse;

FIG. 8 is a flowchart describing an example of the printing process;

FIG. 9 is an explanatory diagram that illustrates the relationship between the print area P and the medium S during normal printing;

FIG. 10 is an explanatory diagram that illustrates the relationship between the print area P and the medium S during borderless printing;

FIG. 11 is a plan view showing an embodiment of the ink collecting section;

FIG. 12 is a perspective view showing an embodiment of the ink collecting section;

FIG. 13 is a sectional view showing an embodiment of the ink collecting section;

FIG. 14 is an explanatory diagram that illustrates another example of borderless printing;

FIG. 15 is an explanatory diagram that describes an embodiment of the optical sensor;

FIG. 16 is an explanatory diagram illustrating an example of the medium detection process;

FIG. 17 is an explanatory diagram that describes the signals output from the optical sensor;

FIG. 18 is an explanatory diagram that shows an example of an instance where a blot has occurred on the platen;

FIG. 19 is an explanatory diagram that describes the problem that occurs due to a dirty platen;

FIG. 20 is a plan view for describing a method of inspecting the platen;

FIG. 21 is a lateral view for describing a method of inspecting the platen;

FIG. 22 is an explanatory diagram that shows an example of the signals that are output from the sensor during inspection;

FIG. 23 is a flowchart that illustrates an example of the procedure for inspecting the platen;

FIG. 24 is a flowchart that illustrates an example of the procedure when resetting the threshold value;

FIG. 25A is a diagram that illustrates the sampling period when detecting the medium, and FIG. 25B is a diagram that illustrates the sampling period when inspecting the platen;

FIG. 26A describes the sampling results when inspection of the platen is performed at a short sampling period, and FIG. 26B describes the sampling results when detection of the medium is performed at a long sampling period;

FIG. 27 is a perspective view describing an embodiment of a printing system; and

FIG. 28 is a block diagram showing the configuration of the printing system of FIG. 27.

### DETAILED DESCRIPTION OF THE INVENTION

At least the following matters will become clear by the description below and the accompanying drawings.

A printing method comprises the steps of: emitting light from a light-emitting section of an optical sensor toward a support member for supporting a medium, the support member being provided with an ink collecting section for collecting ink that has been ejected from an ink ejecting section and that has landed outside of the medium; changing a threshold value based on a signal that is output from the optical sensor in correspondence with an intensity of light reflected by the support member and received by a light-receiving section of the optical sensor; and detecting the medium by comparing the signal that is output from the optical sensor and the threshold value that has been changed.

With such a printing method, the predetermined threshold value is changed based on the signals that are output from the optical sensor when light is emitted from the light-emitting section toward the support member and the light that is reflected by the support member is received by the light-receiving section, even when the support member has become dirty. Therefore, incorrect detection of the medium can be prevented.

In this printing method, the optical sensor may be provided to be movable relative to the support member. By providing the optical sensor such that it can move, then it is possible to emit light toward the support member over the entire movement range of the optical sensor. Thus, it is possible for the light-receiving section to receive light from a broader range.

In this printing method, when the optical sensor is moved relative to the support member, the medium may be detected by comparing the signal that is output from the optical sensor with the threshold value. By comparing the signal that is output from the optical sensor and the threshold value when the optical sensor is moved, the medium can be detected with ease.

In this printing method, when the optical sensor is moved relative to the support member, the threshold value may be changed based on the signal that is output from the optical sensor. By changing the predetermined threshold value based on the signal that is output from the optical sensor when the optical sensor is moved in this way, the predetermined threshold value can be changed to a more suitable value.

In this printing method, a range over which the optical sensor moves relative to the support member when changing the threshold value may span over the entire support member. Setting the movement range of the optical sensor to cover the entire support member allows the predetermined threshold value to be changed to a more suitable value.

In this printing method, a range over which the optical sensor moves relative to the support member when changing the threshold value may be equal to a range over which the optical sensor moves relative to the support member when detecting the medium. By making the movement ranges of the optical sensor equal in this way, the predetermined threshold value can be changed to a more suitable value.

In this printing method, the threshold value may be changed based on a value obtained by sampling, at a predetermined period, the signal that is output from the optical sensor. The predetermined threshold value can be changed with ease if sampling is performed in this manner.

In this printing method, a minimum value or a maximum value may be obtained from the signal that is output from the optical sensor, and the threshold value may be changed based on the minimum value or the maximum value. The predetermined threshold value can be changed with ease by obtaining a minimum value or a maximum value in this way.

In this printing method, the threshold value does not have to be changed when the minimum value or the maximum value does not reach a predetermined reference value. By not changing the predetermined threshold value when the minimum value or the maximum value does not reach a predetermined reference value, changing of the threshold value can be performed appropriately.

In this printing method, when changing the threshold value, light may be emitted from the light-emitting section toward the ink collecting section. Emitting light to the ink collecting section in this way allows the predetermined threshold value to be changed to a more suitable value.

In this printing method, the ink collecting section may be formed as a groove section in the support member. Forming the ink collecting section as a groove in this way allows the ink that has landed outside of the medium to be collected smoothly.

In this printing method, when changing the threshold value, light that is received by the light-receiving section may include light that has been reflected by a recessed/projecting section provided in the support member. Thus, the predetermined threshold value can be changed to a more suitable value even if the light that is received by the light-receiving section includes light that has been reflected by recessed or projecting sections.

In this printing method, the threshold value may be changed based on the signal that is output from the optical sensor when the ink is not being ejected toward the medium by the ink ejecting section. Changing the predetermined threshold value at this timing allows the process to be performed smoothly.

In this printing method, the ink ejecting section, the support member, the ink collecting section, and the optical sensor may be provided in a printing apparatus; and the threshold value may be changed based on the signal that is output from the optical sensor when power of the printing apparatus is turned on. Changing the predetermined threshold value at this timing allows the process to be performed smoothly.

In this printing method, an execution history of borderless printing, in which printing is carried out by ejecting ink toward an edge of the medium from the ink ejecting section, may be stored on a memory; and when the borderless printing is executed, the execution history stored on the memory may be checked, and if the borderless printing has not been executed before, then the threshold value may be changed based on the signal that is output from the optical sensor when light is emitted from the light-emitting section toward the support member and the light that is reflected by the support member is received by the light-receiving section. Changing the predetermined threshold value when borderless printing has not been performed yet allows a more suitable threshold value to be obtained.

Further, a printing method comprises the steps of: emitting light from a light-emitting section of an optical sensor toward a support member for supporting a medium, the support member being provided with an ink collecting section for collecting ink that has been ejected from an ink ejecting section and that has landed outside of the medium; changing a threshold value based on a signal that is output from the optical sensor in correspondence with an intensity of light reflected by the support member and received by a light-receiving section of the optical sensor; and detecting the medium by comparing the signal that is output from the optical sensor and the threshold value that has been changed; wherein the optical sensor is provided to be movable relative to the support member; wherein when the optical sensor is moved relative to the support member, the medium is detected by comparing the signal that is output from the optical sensor with the threshold value; wherein when the optical sensor is moved relative to the support member, the threshold value is changed based on the signal that is output from the optical sensor; wherein a range over which the optical sensor moves relative to the support member when changing the threshold value spans over the entire support member; wherein a range over which the optical sensor moves relative to the support member when changing the threshold value is equal to a range over which the optical sensor moves relative to the support member when detecting the medium; wherein the threshold value is changed based on a value obtained by sampling, at a predetermined period, the signal that is output from the optical sensor; wherein a minimum value or a maximum value is obtained from the signal that is output from the optical sensor, and the threshold value is changed based on the minimum value or the maximum value; wherein the threshold value is not changed when the minimum value or the maximum value does not reach a predetermined reference value; wherein when changing the threshold value, light is emitted from the light-emitting section toward the ink collecting section; wherein the ink collecting section is formed as a groove section in the support member; wherein when changing the threshold value, light that is received by the light-receiving section includes light that has been reflected by a recessed/projecting section provided in the support member; wherein the threshold value is changed based on the signal that is output from the optical sensor when the ink is not being ejected toward the medium by the ink ejecting section; wherein the ink ejecting section, the support member, the ink collecting section, and the optical sensor are provided in a printing apparatus; wherein the threshold value is changed based on the signal that is output from the optical sensor when power of the printing apparatus is turned on; wherein an execution history of borderless printing, in which printing is carried out by ejecting ink toward an edge of the medium from the ink ejecting section, is stored on a memory; and wherein when the borderless printing is executed, the execution history stored on the memory is checked, and if the borderless printing has not been executed before, then the threshold value is changed based on the signal that is output from the optical sensor when light is emitted from the light-emitting section toward the support member and the light that is reflected by the support member is received by the light-receiving section.

Further, a method of detecting a medium, comprises the steps of: emitting light from a light-emitting section of an optical sensor toward a support member for supporting a medium, the support member being provided with an ink collecting section for collecting ink that has been ejected from an ink ejecting section and that has landed outside of the medium; changing a threshold value based on a signal that is output from the optical sensor in correspondence with an intensity of light reflected by the support member and received by a light-receiving section of the optical sensor; and detecting the medium by comparing the signal that is output from the optical sensor and the threshold value that has been changed.

Further, a computer-readable storage medium has recorded thereon a program, wherein the program causes a printing apparatus provided with: an ink ejecting section that ejects ink onto a medium to perform printing; a support member that supports the medium being printed by the ink ejecting section; an ink collecting section that is provided in the support member and that collects ink that has been ejected from the ink ejecting section and landed outside of the medium; and an optical sensor that is provided in opposition to the support member, that has a light-emitting section that emits light and a light-receiving section that receives light, and that outputs a signal that corresponds to an intensity of the light received by the light-receiving section; the printing apparatus being configured to detect the medium by comparing the signal that is output from the optical sensor and a threshold value; to execute the steps of: obtaining the signal that is output from the optical sensor when light is emitted from the light-emitting section toward the support member and the light that is reflected by the support member is received by the light-receiving section; and changing the threshold value based on the signal that has been obtained.

Further, a printing apparatus comprises: an ink ejecting section that ejects ink onto a medium to perform printing; a support member that supports the medium being printed by the ink ejecting section; an ink collecting section that is provided in the support member and that collects ink that has been ejected from the ink ejecting section and landed outside of the medium; and an optical sensor that is provided in opposition to the support member, that has a light-emitting section that emits light and a light-receiving section that receives light, and that outputs a signal that corresponds to an intensity of the light received by the light-receiving section; wherein the medium is detected by comparing the signal that is output from the optical sensor and a threshold value; and wherein the threshold value is changed based on the signal that is output from the optical sensor when light is emitted from the light-emitting section toward the support member and the light that is reflected by the support member is received by the light-receiving section.

Further, a printing method comprises the steps of: when inspecting a condition of a supporting section that supports a medium being printed by a printing section, changing a threshold value based on a value that is obtained by sampling, at a different period from a predetermined period, a signal that is generated by an optical sensor in correspondence with an intensity of light emitted onto the supporting section from a light-emitting section of the optical sensor and reflected by the supporting section and received by a light-receiving section of the optical sensor when the optical sensor is moved relative to the supporting section; and when performing printing, detecting the medium by comparing the threshold value that has been changed and a value that is obtained by sampling, at the predetermined period, the signal that is generated by the optical sensor when the optical sensor is moved relative to the supporting section.

With this printing method, incorrect detection of the medium can be prevented because, when inspecting the condition of the supporting section, the threshold value is changed based on a value that is obtained by sampling a signal that is generated by the optical sensor when the optical sensor is moved relative to the supporting section. Further, inspection of the supporting section can be executed efficiently because the period of the sampling that is performed when inspecting the condition of the supporting section is different from the period of the sampling that is performed when performing printing.

In this printing method, the period for the sampling that is executed when inspecting the condition of the supporting section may be shorter than the period for the sampling that is executed when performing printing. Setting the period of the sampling that is executed during inspection of the condition of the supporting section to be shorter than the period of the sampling that is performed during printing allows inspection of the supporting section to be executed efficiently.

In this printing method, the same controller may perform the sampling that is executed when inspecting the condition of the supporting section and the sampling that is executed when performing printing. Performing the two sampling processes using the same controller allows inspection of the supporting section to be performed efficiently.

In this printing method, a movement velocity when the optical sensor is moved relative to the supporting section during printing may be different from a movement velocity when the optical sensor is moved relative to the supporting section during inspection of the condition of the supporting section. Adopting different movement velocities allows inspection of the supporting section to be performed efficiently.

In this printing method, the movement velocity when the optical sensor is moved relative to the supporting section during inspection of the condition of the supporting section may be faster than the movement velocity when the optical sensor is moved relative to the supporting section during printing. Setting the movement velocity of the optical sensor during inspection of the condition of the supporting section faster than the movement velocity of the optical sensor during printing allows inspection of the supporting section to be executed efficiently.

In this printing method, a range over which the optical sensor moves relative to the supporting section when changing the threshold value may span over the entire supporting section. Making the movement range of the optical sensor cover the entire supporting section allows a more appropriate inspection to be performed.

In this printing method, a range over which the optical sensor moves relative to the supporting section when changing the threshold value may be equal to a range over which the optical sensor moves relative to the supporting section when detecting the medium. More suitable inspection can be executed when the movement ranges of the optical sensor are equal.

In this printing method, a minimum value or a maximum value may be obtained from the signal that is output from the optical sensor, and the threshold value may be changed based on the minimum value or the maximum value. Obtaining a minimum value or a maximum value allows the predetermined threshold value to be changed to a more suitable value.

In this printing method, the threshold value does not have to be changed when the minimum value or the maximum value does not reach a predetermined reference value. Not changing the predetermined threshold value when the minimum value or the maximum value does not reach a predetermined reference value allows changing of the threshold value to be performed appropriately.

In this printing method, the condition of the supporting section may be inspected when printing is not being performed with respect to the medium by the printing section. Performing inspection at this timing allows inspection to be performed smoothly.

In this printing method, the printing section, the supporting section, and the optical sensor may be provided in a printing apparatus; and the condition of the supporting section may be inspected when power of the printing apparatus is turned on. Performing inspection at this timing allows inspection to be performed smoothly.

In this printing method, an execution history of borderless printing, in which printing is carried out by ejecting ink toward an edge of the medium from the printing section, may be stored on a memory; and when the borderless printing is executed, the execution history stored on the memory may be checked, and if the borderless printing has not been executed before, then the threshold value may be changed based on the signal that is output from the optical sensor when light is emitted from the light-emitting section toward the supporting section and the light that is reflected by the supporting section is received by the light-receiving section. Changing the predetermined threshold value when borderless printing has not been performed yet allows a more suitable threshold value to be obtained.

In this printing method, the printing section may perform printing by ejecting ink toward the medium. The present invention can be favorably adopted in a printing apparatus that performs printing by ejecting ink.

Further, a printing method comprises the steps of: when inspecting a condition of a supporting section that supports a medium being printed by a printing section, changing a threshold value based on a value that is obtained by sampling, at a period that is shorter than a predetermined period, a signal that is generated by an optical sensor in correspondence with an intensity of light emitted onto the supporting section from a light-emitting section of the optical sensor and reflected by the supporting section and received by a light-receiving section of the optical sensor when the optical sensor is moved relative to the supporting section; and when performing printing, detecting the medium by comparing the threshold value that has been changed and a value that is obtained by sampling, at the predetermined period, the signal that is generated by the optical sensor when the optical sensor is moved relative to the supporting section; wherein a same controller performs the sampling that is executed when inspecting the condition of the supporting section and the sampling that is executed when performing printing; wherein a movement velocity when the optical sensor is moved relative to the supporting section during inspection of the condition of the supporting section is faster than a movement velocity when the optical sensor is moved relative to the supporting section during printing; wherein a range over which the optical sensor moves relative to the supporting section when changing the threshold value spans over the entire supporting section; wherein a range over which the optical sensor moves relative to the supporting section when changing the threshold value is equal to a range over which the optical sensor moves relative to the supporting section when detecting the medium; wherein a minimum value or a maximum value is obtained from the signal that is output from the optical sensor, and the threshold value is changed based on the minimum value or the maximum value; wherein the threshold value is not changed when the minimum value or the maximum value does not reach a predetermined reference value; wherein the printing section, the supporting section, and the optical sensor are provided in a printing apparatus; wherein the condition of the supporting section is inspected when printing is not being performed with respect to the medium by the printing section and when power of the printing apparatus is turned on; wherein an execution history of borderless printing, in which printing is carried out by ejecting ink toward an edge of the medium from the printing section, is stored on a memory; wherein when the borderless printing is executed, the execution history stored on the memory is checked, and if the borderless printing has not been executed before, then the threshold value is changed based on the signal that is output from the optical sensor when light is emitted from the light-emitting section toward the supporting section and the light that is reflected by the supporting section is received by the light-receiving section; and wherein the printing section performs printing by ejecting ink toward the medium.

Further, a method of detecting a medium, comprises the steps of: when inspecting a condition of a supporting section that supports a medium being printed by a printing section, changing a threshold value based on a value that is obtained by sampling, at a different period from a predetermined period, a signal that is generated by an optical sensor in correspondence with an intensity of light emitted onto the supporting section from a light-emitting section of the optical sensor and reflected by the supporting section and received by a light-receiving section of the optical sensor when the optical sensor is moved relative to the supporting section; and when performing printing, detecting the medium by comparing the threshold value that has been changed and a value that is obtained by sampling, at the predetermined period, the signal that is generated by the optical sensor when the optical sensor is moved relative to the supporting section.

Further, a computer-readable storage medium has recorded thereon a program, wherein the program causes a printing apparatus provided with: a printing section that performs printing with respect to a medium; a supporting section that supports the medium being printed by the printing section; and an optical sensor that is provided in opposition to the supporting section, that is movable relative to the supporting section, that has a light-emitting section that emits light and a light-receiving section that receives light, and that generates a signal that corresponds to an intensity of the light received by the light-receiving section; the printing apparatus being configured to detect, when performing printing, the medium by comparing a threshold value and a value that is obtained by sampling, at a predetermined period, the signal that is generated by the optical sensor when the optical sensor is moved relative to the supporting section; to execute the steps of: when inspecting a condition of the supporting section, sampling, at a different period from the predetermined period, the signal that is generated by the optical sensor when the optical sensor is moved relative to the supporting section; and changing the threshold value based on a value that is obtained through the sampling.

Further, a printing apparatus comprises: a printing section that performs printing with respect to a medium; a supporting section that supports the medium being printed by the printing section; and an optical sensor that is provided in opposition to the supporting section, that is movable relative to the supporting section, that has a light-emitting section that emits light and a light-receiving section that receives light, and that generates a signal that corresponds to an intensity of the light received by the light-receiving section; wherein when performing printing, the medium is detected by comparing a threshold value and a value that is obtained by sampling, at a predetermined period, the signal that is generated by the optical sensor when the optical sensor is moved relative to the supporting section; and wherein when inspecting a condition of the supporting section, the threshold value is changed based on a value that is obtained by sampling, at a different period from the predetermined period, the signal that is generated by the optical sensor when the optical sensor is moved relative to the supporting section.

===Outline of Printing Apparatus===

An embodiment of a printing apparatus according to the present invention is described with an inkjet printer serving as an example.

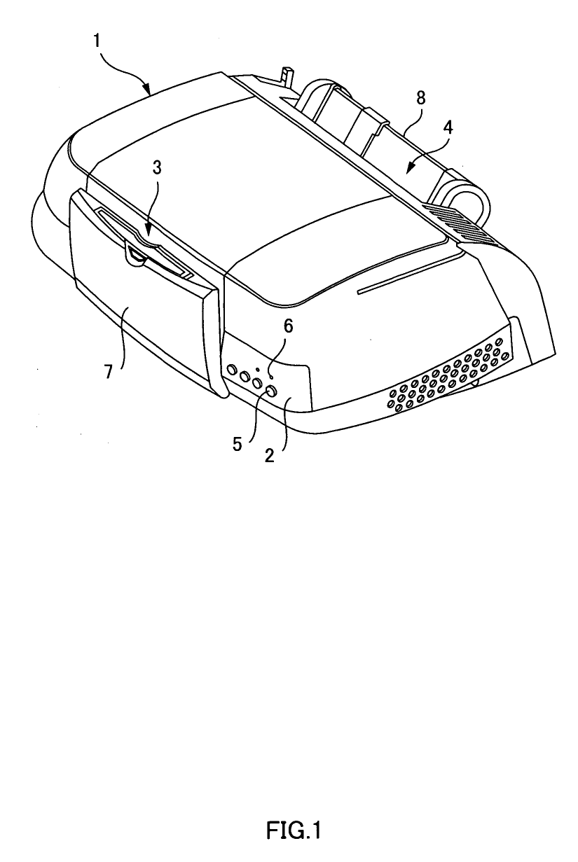

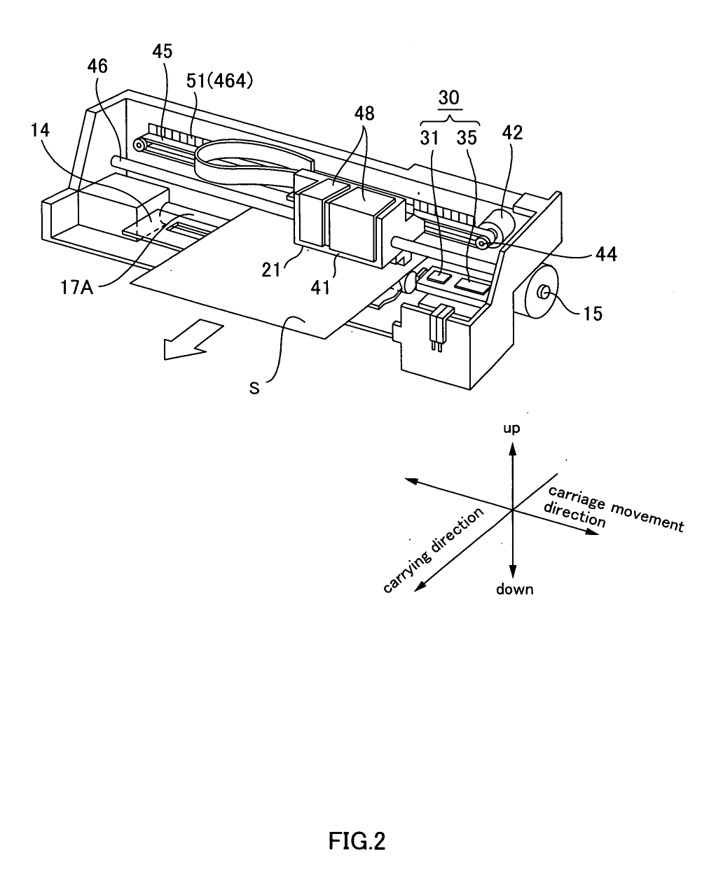

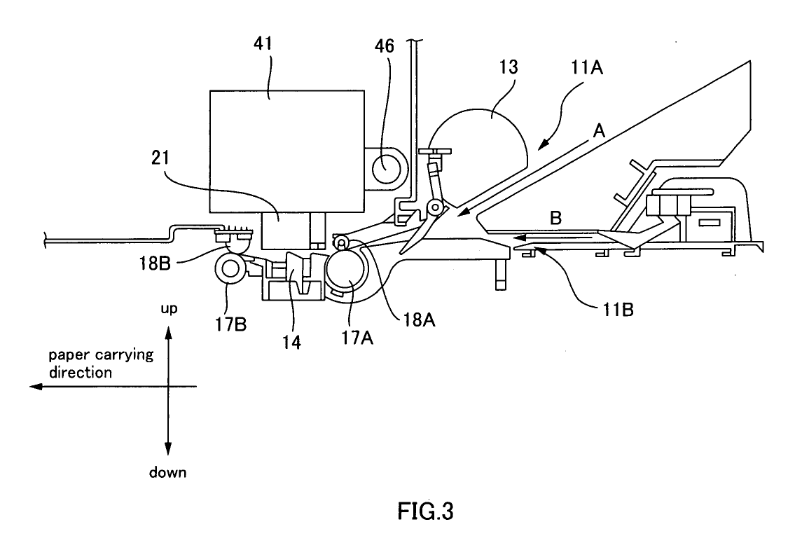

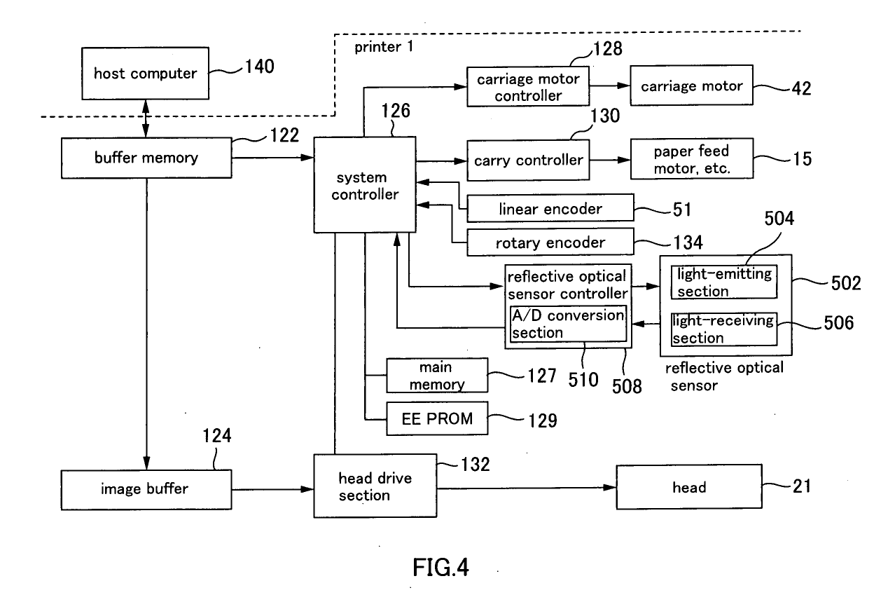

FIGS. 1 to 4 show an inkjet printer 1. FIG. 1 shows an external view of the inkjet printer 1. FIG. 2 shows the internal configuration of the inkjet printer 1. FIG. 3 shows a carrying section of the inkjet printer 1. FIG. 4 is a block configuration diagram showing the system configuration of the inkjet printer 1.

As shown in FIG. 1, the inkjet printer 1 is provided with a structure in which a medium such as print paper that is supplied through its rear side is discharged through its front side. A control panel 2 and a paper discharge section 3 are provided at the front side area, and a paper supply section 4 is provided at the rear side area. The control panel 2 is provided with various types of control buttons 5 and display lamps 6. The paper discharge section 3 is provided with a paper discharge tray 7 that covers the paper discharge opening when the inkjet printer is not in use. The paper supply section 4 is provided with a paper supply tray 8 for holding cut paper (not shown). It should be noted that it is also possible for the inkjet printer 1 to be provided with a paper supply structure that is capable of printing not only print paper in single sheets, such as cut paper, but also continuous media such as roll paper.

As shown in FIG. 2, a carriage 41 is arranged inside the inkjet printer 1. The carriage 41 is arranged such that it can move in a relative manner along a predetermined direction (the transverse direction in the figure). A carriage motor (hereafter also referred to as “CR motor”) 42, a pulley 44, a timing belt 45, and a guide rail 46 are provided in the vicinity of the carriage 41. The carriage motor 42 is constituted by a DC motor or the like and functions as a drive source for moving the carriage 41 in a relative manner in the predetermined direction. The timing belt 45 is connected to the carriage motor 42 via the pulley 44 and a portion thereof is also connected to the carriage 41, such that the carriage 41 is moved in a relative manner in the predetermined direction by the rotational driving of the carriage motor 42. The guide rail 46 guides the carriage 41 in the predetermined direction.

In addition to these, a linear encoder 51 that detects the position of the carriage 41, a carry roller 17A for carrying a medium S in a direction that intersects the movement direction of the carriage 41, and a paper feed motor 15 that rotationally drives the carry roller 17A also are provided in the vicinity of the carriage 41.

On the other hand, ink cartridges 48 that contain various types of inks and a head 21 for executing printing with respect to the medium S are provided in the carriage 41. The ink cartridges 48 contain inks of various colors such as yellow (Y), magenta (M), cyan (C), and black (K), and are removably mounted to a carriage mounting section provided in the carriage 41. In this embodiment, the head 21 prints by ejecting ink onto the medium S. For this reason, numerous nozzles for ejecting ink are provided in the head 21. Detailed description of the ink ejecting mechanism of the head 21 is provided later.

Additionally, a cleaning unit 30 for eliminating clogging of the nozzles of the head 21 is arranged inside the inkjet printer 1. The cleaning unit 30 has a pump device 31 and a capping device 35. The pump device 31 sucks out ink from the nozzles in order to eliminate clogging of the nozzles of the head 21, and is operated by a pump motor (not shown). On the other hand, the capping device 35 is for sealing the nozzles of the head 21 when printing is not being performed (during standby etc.) to keep the nozzles of the head 21 from clogging.

Further, a platen 14 for supporting the medium S, which is being printed, from below is provided inside the inkjet printer 1 and below the head 21. The platen 14 is arranged in opposition to the head 21 along the movement direction of the head 21 (carriage 41).

The configuration of the carrying section of the inkjet printer 1 is described next. As shown in FIG. 3, the carrying section has a paper insert opening 11A and a roll paper insert opening 11B, a paper supply motor (not shown), a paper supply roller 13, the platen 14, a paper feed motor (hereinafter, also referred to as PF motor) 15, the carry roller 17A and paper discharge rollers 17B, and free rollers 18A and free rollers 18B. In the present embodiment, the platen 14 corresponds to the “supporting section” and the “support member that supports the medium being printed”.

The paper insert opening 11A is where the medium S, which is a medium, is inserted. The paper supply motor (not shown) is a motor for carrying the medium S that has been inserted into the paper insert opening 11A into the inkjet printer 1, and is constituted by a pulse motor or the like. The paper supply roller 13 is a roller for automatically carrying, into the inkjet printer 1, the medium S that has been inserted into the paper insert opening 11A in the arrow A direction in the figure (in the case of roll paper, the arrow B direction), and is driven by the paper supply motor. The paper supply roller 13 has a transverse cross-sectional shape that is substantially the shape of the letter D. The circumferential length of a circumference section of the paper supply roller 13 is set longer than the carrying distance up to the carry roller 17A, so that using this circumference section the medium S can be carried up to the carry roller 17A. It should be noted that a plurality of media S are prevented from being supplied at one time by the rotational drive force of the paper supply roller 13 and the friction resistance of separating pads (not shown).

The platen 14 is a support means that supports the medium S during printing. The paper feed motor 15 is a motor for advancing paper, which is an example of the medium S, in the paper carrying direction, and is constituted by a DC motor. The carry roller 17A is a roller for advancing the medium S that has been carried into the inkjet printer 1 by the paper supply roller 13 up to a printable region, and is driven by the paper feed motor 15. The free rollers 18A are provided at a position that is in opposition to the carry roller 17A, and push the medium S toward the carry roller 17A by sandwiching the medium S between them and the carry roller 17A.

The paper discharge rollers 17B are rollers for discharging a medium S for which printing has finished to outside the inkjet printer 1. The paper discharge rollers 17B are driven by the paper feed motor 15 through a gear wheel that is not shown in the drawings. The free rollers 18B are provided at a position that is in opposition to the paper discharge rollers 17B, and push the medium S toward the paper discharge rollers 17B by sandwiching the medium S between them and the paper discharge rollers 17B.

<System Configuration>

The following is a description of the system configuration of the inkjet printer 1. As shown in FIG. 4, the inkjet printer 1 is provided with a buffer memory 122, an image buffer 124, a system controller 126, a main memory 127, and an EEPROM 129. The buffer memory 122 receives and temporarily stores various data such as print data that have been sent from a host computer 140. The image buffer 124 obtains the received print data from the buffer memory 122 and stores them. The main memory 127 is constituted by a flash memory such as a ROM or a RAM. It should be noted that the system controller 126 corresponds to the “controller”.

On the other hand, the system controller 126 reads out a control program from the main memory 127 and executes overall control of the inkjet printer 1 in accordance with that control program. The system controller 126 of the present embodiment is provided with a carriage motor controller 128, a carry controller 130, a head drive section 132, a rotary encoder 134, and a linear encoder 51. The carriage motor controller 128 executes driving control of the rotation direction, number of rotations, and torque, for example, of the carriage motor 42. Also, the head drive section 132 performs driving control of the head 21. The carry controller 130 controls the various drive motors that are disposed in the carry system, such the paper feed motor 15 that rotatively drives the carry roller 17A.

Print data that have been sent from the host computer 140 are temporarily held in the buffer memory 122. Necessary information contained in the print data held here is read out by the system controller 126. Based on the information that is read out, the system controller 126 controls the carriage motor controller 128, the carry controller 130, and the head drive section 132 in accordance with the control program while referencing the output from the linear encoder 51 and the rotary encoder 134.

Print data for a plurality of color components received by the buffer memory 122 are stored in the image buffer 124. The head drive section 132 obtains print data of the various color components from the image buffer 124 according to control signals from the system controller 126, and drives and controls the various color nozzles provided in the head 21 based on the print data.

It should be noted that the inkjet printer 1 according to this embodiment is additionally provided with a reflective optical sensor 502 and a reflective optical sensor controller 508. The reflective optical sensor 502 and the reflective optical sensor controller 508 will be described in detail later.

<Head>

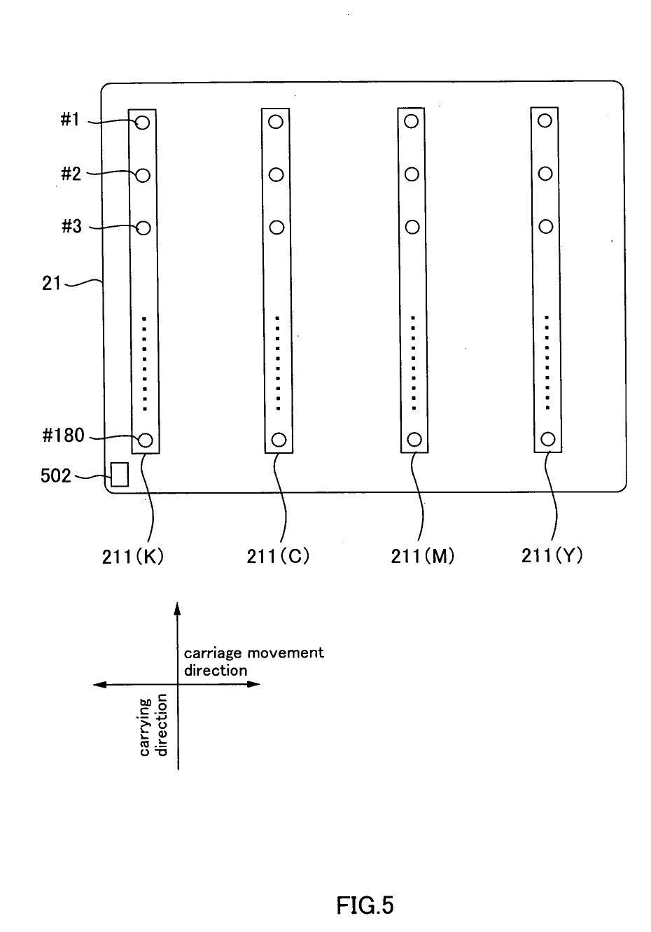

FIG. 5 shows the arrangement of the ink nozzles provided on the lower surface of the head 21. As shown in this diagram, nozzle rows 211, each constituted by a plurality of nozzles #1 to #180 for the respective colors yellow (Y), magenta (M), cyan (C), and black (K), are provided in the lower surface of the head 21. It should be noted that the nozzles #1 to #180 of the nozzle rows 211 for the respective colors yellow (Y), magenta (M), cyan (C), and black (K) correspond to the “ink ejecting section” and the “printing section”.

The nozzles #1 to #180 of each of the nozzle rows 211 are arranged in a straight line in the carrying direction of the medium S. The nozzle rows 211 are disposed parallel to one another, with a spacing between them, in the movement direction (scanning direction) of the head 21. The nozzles #1 to #180 are provided with piezo elements (not shown) as drive elements for ejecting ink droplets.

When a voltage of a predetermined duration is applied between electrodes provided on both ends of a piezo element, the piezo element is elongated for that duration of voltage application and deforms the lateral wall of the ink channel. This causes the volume of the ink channel to be constricted by an amount that corresponds to the elongation of the piezo element, and an amount of ink corresponding to this constriction amount is ejected from the relevant color nozzle #1 to #180 as an ink droplet.

===Linear Encoder ===

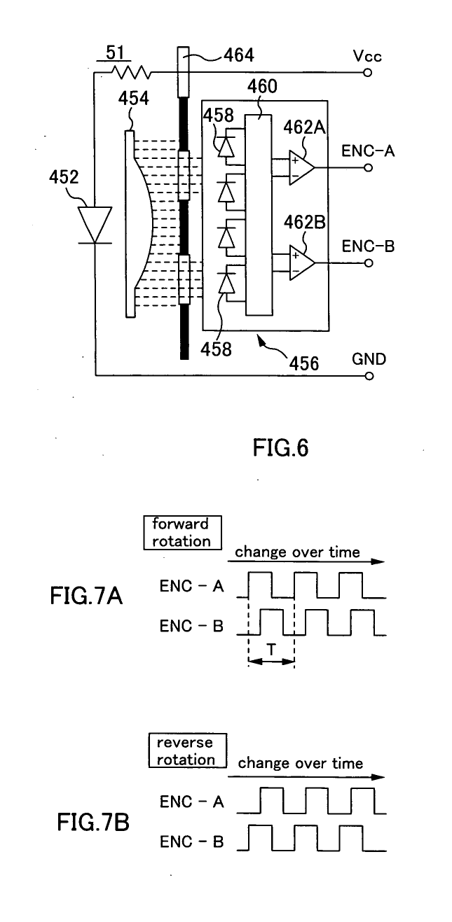

The linear encoder 51 is described in detail next. FIG. 6 schematically shows the configuration of the linear encoder 51 provided in the carriage 41.

The linear encoder 51 is provided with a light-emitting diode 452, a collimating lens 454, and a detection processing section 456. The detection processing section 456 has a plurality of (for instance, four) photodiodes 458, a signal processing circuit 460, and for example two comparators 462A and 462B.

The light-emitting diode 452 emits light when a voltage Vcc is applied to it via resistors on both sides. This light is focused into parallel light by the collimating lens 454 and passes through a linear encoder code plate 464. The linear encoder code plate 464 is provided with slits at a predetermined spacing (for example, 1/180 inch (one inch=2.54 cm)).

The parallel light that passes through the linear encoder code plate 464 then passes through stationary slits (not shown) and is incident on the photodiodes 458, where it is converted into electrical signals. The electrical signals that are output from the four photodiodes 458 are subjected to signal processing in the signal processing circuit 460, and the signals that are output from the signal processing circuit 460 are compared in the comparators 462A and 462B, and the results of these comparisons are output as pulses. The pulse ENC-A and the pulse ENC-B that are output from the comparators 462A and 462B become the output of the linear encoder 51.

FIG. 7A and FIG. 7B are timing charts showing the waveforms of the two output signals of the linear encoder 51 when the carriage motor 42 is rotating forward and rotating in reverse. As shown in FIGS. 7A and 7B, the phases of the pulse ENC-A and the pulse ENC-B are misaligned by 90 degrees both when the carriage motor 42 is rotating forward and when it is rotating in reverse. When the carriage motor 42 is rotating forward, that is, when the carriage 41 is moving along the guide rail 46, then, as shown in FIG. 7A, the phase of the pulse ENC-A leads the phase of the pulse ENC-B by 90 degrees, and when the carriage motor 42 is rotating in reverse, then, as shown in FIG. 7B, the phase of the pulse ENC-A trails the phase of the pulse ENC-B by 90 degrees. A single period T of the pulse ENC-A and the pulse ENC-B is equal to the time during which the carriage 41 is moved by the slit spacing of the linear encoder code plate 464.

Then, the rising edge and the falling edge of the output pulses ENC-A and ENC-B of the linear encoder 51 are detected, the number of detected edges is counted, and the rotational position of the carriage motor 42 is calculated based on the value of the count. As regards this counting process, when the carriage motor 42 is rotating forward, a “+1” is added for each detected edge, and when it is rotating in reverse, a “−1” is added for each detected edge. The periods of the pulses ENC-A and ENC-B are equal to the time from when one slit of the linear encoder code plate 464 passes through the linear encoder 51 to when the next slit passes through the linear encoder 51, and the phases of the pulse ENC-A and the pulse ENC-B are different by 90 degrees. Accordingly, a count number of “1” corresponds to ¼ of the slit spacing of the linear encoder code plate 464. Therefore, if the counted number is multiplied by ¼ of the slit spacing, then based on the product that is obtained it is possible to find the amount that the carriage motor 42 has moved from the rotational position corresponding to the count number “0.” The resolution of the linear encoder 51 in this example is ¼ the slit spacing of the linear encoder code plate 464.

===Printing Operation===

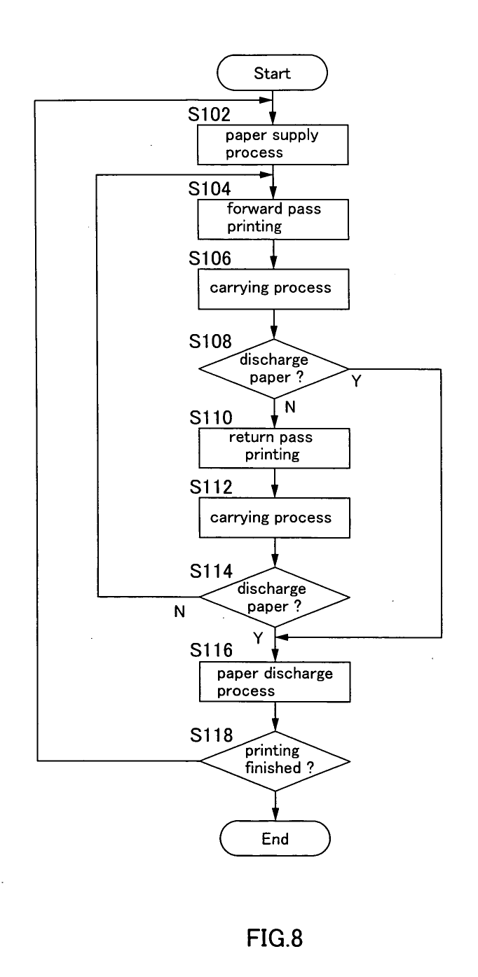

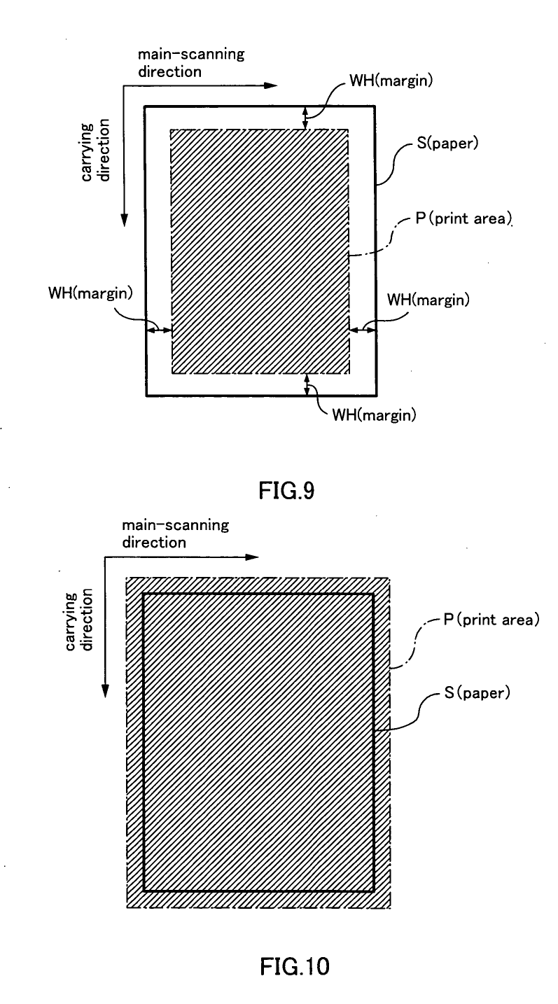

The printing operation of the inkjet printer 1 discussed above is described next. Here, an example of “bidirectional printing” is described. FIG. 8 is a flowchart showing an example of the procedure of the printing operation of the inkjet printer 1. The processes described below are executed by the system controller 126 reading a program stored on the main memory 127 or the EEPROM 129 and controlling the various units in accordance with this program.

When the system controller 126 receives print data from the host computer 140, it first performs a paper supply process (S102) to execute printing based on those print data. The paper supply process is a process for supplying a medium S (such as paper) to be printed into the inkjet printer 1 and carrying it up to a print start position (also referred to as the “indexed position”). The system controller 126 rotates the paper supply roller 13 to feed the medium S to be printed up to the carry roller 17A. The system controller 126 rotates the carry roller 17A to position the medium S that has been fed from the paper supply roller 13 at the print start position.

Next, the system controller 126 executes a printing process in which the carriage 41 is moved relative to the medium S and printing is executed with respect to the medium S. Here, first a forward pass printing of moving the carriage 41 in one direction along the guide rail 46 while ejecting ink from the head 21 is performed (S104). The system controller 126 drives the carriage motor 42 to move the carriage 41 and also drives the head 21 to eject ink based on the print data. The ink that is ejected from the head 21 reaches the medium S and forms dots.

After printing has been executed in this manner, a carrying process of carrying the medium S by a predetermined amount is performed (S106). In this carrying process the system controller 126 drives the paper feed motor 15 to rotate the carry roller 17A so as to carry the medium S by a predetermined amount in the carrying direction relative to the head 21. By performing this carrying process, the head 21 can print on an area different from the area printed previously.

After carrying has been performed in this manner, a paper discharge determination of whether or not to discharge the paper is performed (S108). Here, if there are no more data to be printed on the medium S being printed, then a paper discharge process is performed (S116). On the other hand, if there still is data to be printed on the medium S being printed, then a return pass printing is executed without performing the paper discharge process (S110). In the return pass printing, printing is performed by moving the carriage 41 along the guide rail 46 in the direction opposite from that of the immediately-prior forward pass printing. Similar to the above-mentioned process, the system controller 126 rotatively drives the carriage motor 42 in a direction opposite from the above-described direction to move the carriage 41 and drives the head 21 to eject ink based on the print data, thereby executing printing.

After the return pass printing has been performed, the carrying process is executed (S112) and then the paper discharge determination is performed (S114). Here, if there still is data to be printed on the medium S being printed, then the procedure is returned to S104 without performing the paper discharge process and forward pass printing is performed again (S104). On the other hand, if there are no more data to be printed on the medium S being printed, then the paper discharge process is performed (S116).

Once the paper discharge process has been performed, next a printing finished determination is executed to determine whether or not printing is finished (S118). Here, the system controller 126 checks whether or not there is a next medium S to be printed based on the print data from the host computer 140. If there is a next medium S to be printed, then the procedure is returned to step S102 and the paper supply process is performed again to start printing. On the other hand, if there is not a next medium S to be printed, then the printing process is ended.

===Borderless Printing===

The inkjet printer 1 according to this embodiment can also execute “borderless printing.”

<Overview of Borderless Printing>

FIGS. 9 and 10 illustrate an overview of “borderless printing” as executed by the inkjet printer 1 of this embodiment. FIG. 9 illustrates the relationship between the paper (medium) S and the print area P when normal printing is performed rather than “borderless printing.” FIG. 10 illustrates the relationship between the medium S and the print area P when “borderless printing” is performed.

In the case of normal printing, FIG. 9 shows how the print area P is set to a size that is smaller than the paper S such that it fits within the paper S. A blank margin portion WH is formed at the left and right portions and at the top and bottom portions of the periphery of the paper S. Processing to keep the print area P within the paper S is performed by a printer driver installed in the host computer 140. The printer driver generates print data so that the print area P fits within the paper S based on the image data supplied from an application program running on the host computer 140. Here, when processing image data with which the print area P cannot be kept within the paper S, the printer driver excludes a portion of the image expressed by the image data from printing or shrinks the image so that it fits on the paper S. The print data thus generated by the printer driver are transmitted from the host computer 140 to the inkjet printer 1. The inkjet printer 1 then performs printing based on the print data that have been sent from the host computer 140, performing normal printing.

In the case of “borderless printing,” however, as shown in FIG. 10 the print area P is set to a size that is larger than the medium S such that it extends beyond the medium S. Unlike the case of normal printing described in FIG. 9, a blank margin portion WH is not formed in the periphery of the medium S. It should be noted that, here, the print area P covers the entire medium S and no blank margin portion WH is formed whatsoever in the periphery of the medium S. However, “borderless printing” is not limited to the case shown in FIG. 10, in which no margin portion is formed whatsoever in the periphery of the medium S, and also includes cases in which a margin portion is formed in some of the periphery portions of the medium S, such as in a left or right edge, or an upper or lower edge of the medium S. That is, a case in which the print area P extends beyond the medium S even slightly is also referred to as “borderless printing.”

The processing to make the print area P extend beyond the medium S is performed by a printer driver or the like, as with the case of normal printing. Based on the image data received from the application program, the printer driver generates print data with which the print area P extends beyond the medium S. Here, when processing image data in which the print area P is smaller than the medium S, the printer driver expands the print area P so that the print area P covers the entire medium S. The print data generated in this manner are transmitted from the host computer 140 to the inkjet printer 1. The inkjet printer 1 then executes “borderless printing” by performing printing based on the print data that have been sent from the host computer 140. An attractive printed product without any margins can thus be achieved.

When performing “borderless printing” in this manner, there are instances in which the ink ejected from the nozzles #1 to #180 of the nozzle rows 211 lands outside of the medium S. Ink that lands outside of the medium S may have a negative effect such as dirtying the platen 14. Accordingly, printing apparatuses that execute “borderless printing” are provided with an ink collecting section for collecting ink that has landed outside of the medium S.

<Ink Collecting Section>

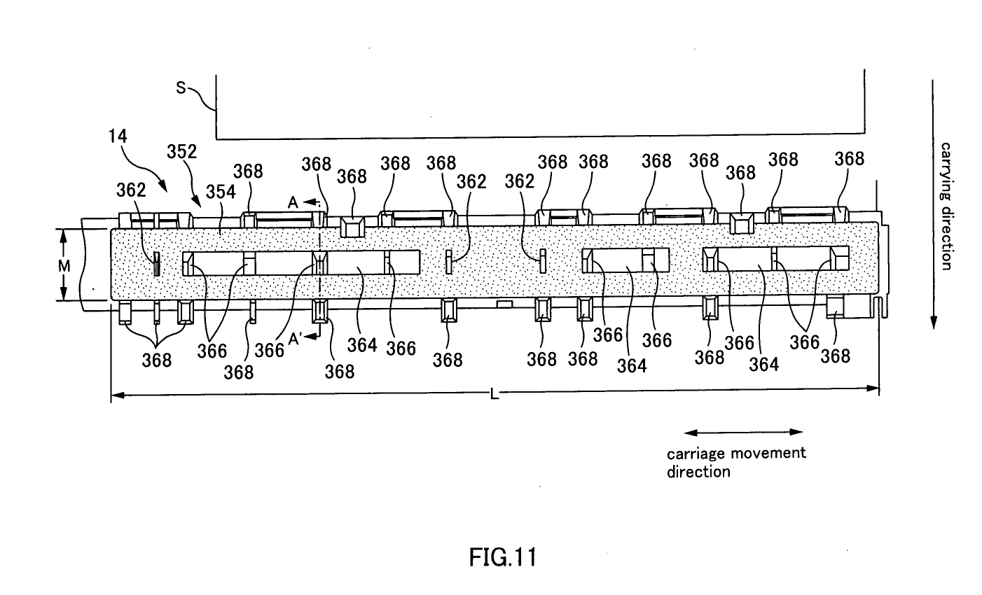

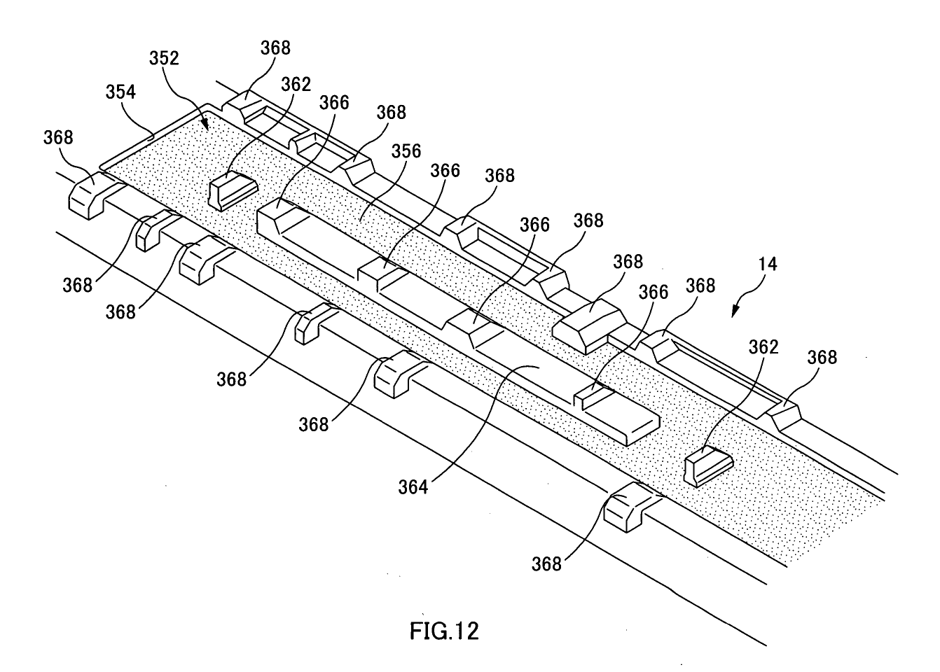

FIG. 11 and FIG. 12 show the platen 14 provided with an ink collecting section 352 according to the present embodiment. FIG. 11 is a plan view showing the overall appearance of the platen 14, and FIG. 12 is a perspective view partially showing the platen 14.

As shown in FIG. 11, the ink collecting section 352 is made of a groove section 354 formed in the platen 14 in the shape of a long rectangular along the movement direction of the carriage 41. The width length (length in the movement direction of the carriage 41) L of the groove section 354 is set to correspond to the maximum size of the medium S that can be printed by the inkjet printer 1. That is, if the A4 size is the maximum size of medium S that can be printed, then the width length L of the groove section 354 is set to a length that corresponds to the width length of an A4 size medium, that is, it is set to a length that is slightly longer than the width length of an A4 size medium. The vertical length (the length in the carrying direction of the medium) M of the groove section 354 is set in correspondence with the length of the nozzle rows 211 provided in the head 21, and is slightly longer than that length. It is thus possible to execute “borderless printing” with respect to all printable media sizes.

The groove section 354 is formed having a recessed cross-sectional shape as shown in FIG. 12. An absorbing material 356 for absorbing the ink that has been discarded is arranged within the groove section 354. The absorbing material 356 is made of material capable of absorbing ink, such as a sponge, and is capable of absorbing and holding ink. Therefore, ink that has been discarded can be kept from spattering.

A plurality of projecting sections 362 and a plurality of rectangular protruding sections 364 are provided within the groove section 354. The projecting sections 362 and the rectangular protruding sections 364 are provided side by side, with a spacing between one another, in the movement direction of the carriage 41, that is, in the lengthwise direction of the groove section 354. A plurality of ribs 366 are integrally provided on the upper surface of the rectangular protruding sections 364. The plurality of ribs 366 are formed side by side, with a spacing between one another, in the movement direction of the carriage 41. The projection sections 362 and the protruding sections 364 are for supporting from below the medium S being printed, which lies above the groove section 354. The upper end portion of the projecting sections 362 and the ribs 366 of the protruding sections 364 come into contact with the lower surface of the medium S and support the medium S.

Additionally, ribs 368 for supporting the medium S from below are formed in the periphery of the groove section 354 as well. The ribs 368 of the periphery of the groove section 354 are disposed side by side, with a spacing between one another, in the movement direction of the carriage 41 on the upper edge portion and the lower edge portion of the groove section 354. By disposing the projecting sections 362 and the ribs 366 and 368 at an appropriate spacing, the medium S being printed can be supported uniformly from below. Thus, bending of the medium S during printing can be prevented.

<Borderless Printing in Practice>

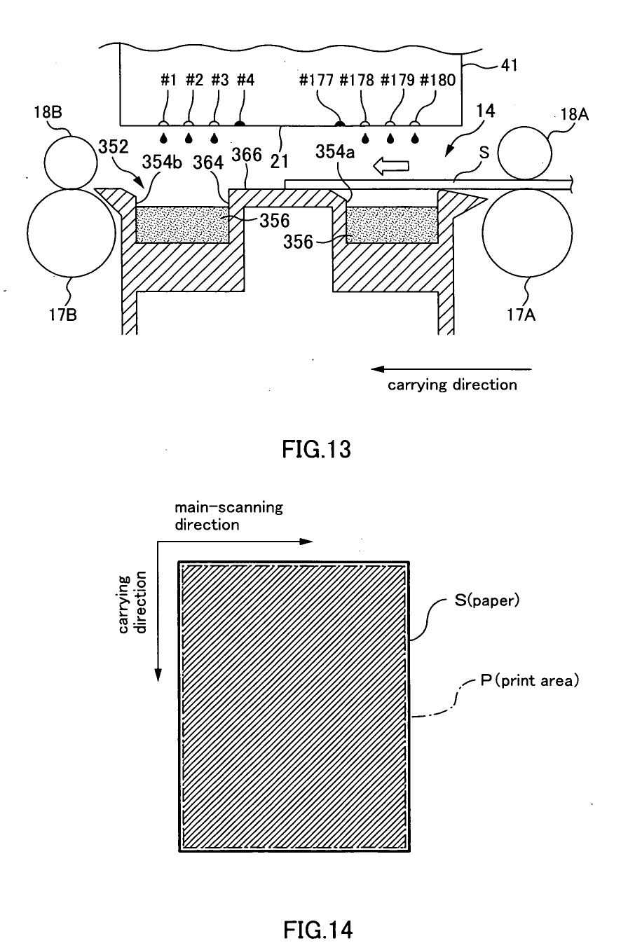

FIG. 13 shows an example of printing when “borderless printing” is executed in practice, and is a sectional view taken in the arrow direction along the line A-A′ in FIG. 11. As shown in the drawing, two groove sections 354a and 354b serving as the groove section 354 are provided in the platen 14 in opposition to the head 21 disposed above the platen 14. The groove section 354a is provided on the upstream side in the carrying direction of the medium S, and is formed in opposition to the nozzles #178 to #180 of the nozzles #1 to #180 of the nozzle rows 211 of the head 21. The other groove section 354b is provided on the downstream side in the carrying direction of the medium S, and is formed in opposition to the nozzles #1 to #3 of the nozzles #1 to #180 of the nozzle rows 211 of the head 21. Thus, the ink ejected from the nozzles #1 to #3 and #178 to #180 of the head 21 is fired directly into the groove sections 354a and 354b when it lands outside of the medium S. The ink that has been fired into the groove sections 354a and 354b is absorbed by the absorbing material 356 within the groove sections 354a and 354b and collected.

When printing on the front end of the medium S in the carrying direction, the nozzles #1 to #3 provided on the downstream side in the carrying direction are used and ink is ejected from the nozzles #1 to #3 to print on the front end of the medium S. Here, the ink that has been ejected from the nozzles #1 to #3 and landed outside of the medium S is collected by the groove section 354b on the downstream side in the carrying direction.

Similarly, when printing on the rear end of the medium S, the nozzles #178 to #180 provided on the upstream side in the carrying direction are used and ink is ejected from these nozzles #178 to #180 to print on the rear end of the medium S. Here, the ink that has been ejected from the nozzles #178 to #180 and landed outside of the medium S is collected by the groove section 354a on the upstream side in the carrying direction.

It should be noted that during normal printing, the front end and the rear end of the medium S are left blank as margin portions WH, and thus it is not necessary to print on these front and rear ends or to discard ink in the groove section 354a on the upstream side or the groove section 354b on the downstream side of the carrying direction, and therefore there is no limitation as to which nozzles should be used as in the case described above, and any of the nozzles #1 to #180 can be used to print on the medium S.

<Another Example of Borderless Printing>

In the foregoing implementation, the print area P is set such that it extends beyond the medium S, but in “borderless printing” it is not always necessary that the print area P is set extending beyond the medium S. FIG. 14 shows an example of “borderless printing” in which, rather than the print area P being set such that it extends beyond the medium S, it is set such that it fits the medium S. As shown in the drawing, “borderless printing” in which there are no margin portions can be executed by setting the print area P such that it perfectly fits the size of the medium S without extending beyond the medium S.

It should be noted that in this case as well, it is not absolutely necessary that no margin portion is formed whatsoever in the periphery of the medium S as shown in FIG. 14, and a case in which a blank margin portion is formed in some of the periphery portions of the medium S, such as in the left, right, upper, or lower edge of the medium S, is also possible. That is, if even a portion of the print area P is set to fit the size of the medium S, this may also be referred to as “borderless printing.”

In such cases as well, the ink is ejected to a position right at the edge of the medium S and thus some of the ink may land outside of the medium S due to positional shifting of the medium S, for example. Thus, it is necessary to collect the ink that lands outside of the medium S even if the print area P has been set to fit perfectly within the medium S. An ink collecting section 352 like the one discussed above thus becomes necessary.

===Detecting the Medium ===

The inkjet printer 1 according to this embodiment is designed such that it detects the position of the medium S is detected when printing on the medium S. The inkjet printer 1 of this embodiment is provided with a reflective optical sensor 502 in order to detect the position of the medium. It should be noted that the reflective optical sensor 502 corresponds to the “optical sensor”.

<Reflective Optical Sensor>

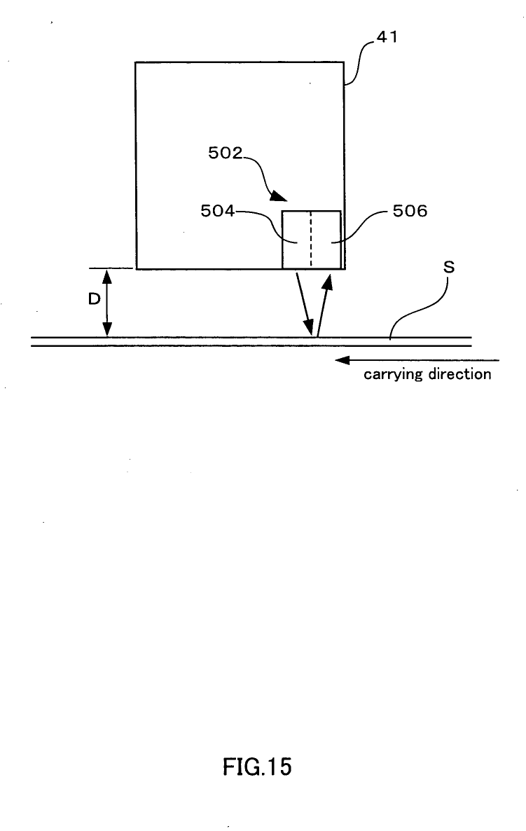

FIG. 15 shows the reflective optical sensor 502. As shown in FIG. 15, the reflective optical sensor 502 is provided in a single unit with the carriage 41, and as shown in FIG. 5, is disposed together with the nozzle rows 211 on the lower surface of the head 21. The reflective optical sensor 502 has a light-emitting section 504 and a light-receiving section 506, and is disposed at a distance D from the medium S. The distance D is set to 5 mm, for example. The light-emitting section 504 and the light-receiving section 506 are both disposed in opposition to the medium S. The light-emitting section 504 is constituted by a light-emitting diode, for example, and emits light toward the medium S. The light-receiving section 506 is constituted by a photodiode, for example, and receives light that has been emitted from the light-emitting section 504 and reflected by the medium S.

The light that is received by the light-receiving section 506 includes a regular reflection component of the light that has been emitted by the light-emitting section 504 and reflected by the medium S. The light-receiving section 506 is disposed at a position where it can receive this regular reflection component.

The light-receiving section 506 generates signals that correspond to the intensity of the light that it receives. The signals generated by the light-receiving section 506 are output from the reflective optical sensor 502 to the outside as detection results. The signals that are output from the reflective optical sensor 502 are input to a reflective optical sensor controller 508 as shown in FIG. 4.

<Reflective Optical Sensor Controller>

The reflective optical sensor controller 508 has the function of controlling the reflective optical sensor 502 according to commands from the system controller 126. That is, due to a command from the system controller 126, the reflective optical sensor controller 508 causes the light-emitting section 504 of the reflective optical sensor 502 to emit light or to stop emitting light, or adjusts the light-reception sensitivity, for example, of the light-receiving section 506 of the reflective optical sensor 502.

Additionally, the reflective optical sensor controller 508 of this embodiment is provided with an A/D conversion section 510, and it also has the function of converting, using this A/D conversion section 510, the signals that are output from the light-receiving section 506 of the reflective optical sensor 502 from analog signals into digital signals. More specifically, the reflective optical sensor controller 508 performs A/D conversion of the signals output from the reflective optical sensor 502 to convert these into digital signals and then outputs these to the system controller 126 as digital data.

<System Controller>

The system controller 126 obtains the detection results of the light-receiving section 506 of the reflective optical sensor 502 from the reflective optical sensor controller 508 as digital data. The system controller 126 then detects the position of the medium S to be printed based on these digital data that are obtained and on the positional information of the carriage 41 that is obtained from the linear encoder 51.

<Actual Detection Process>

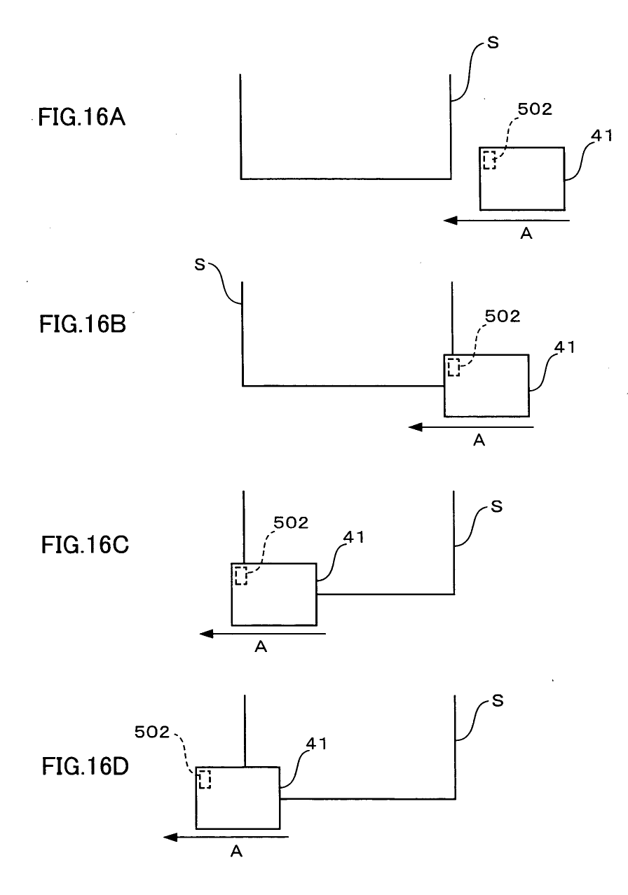

An example of actual processing is illustrated below. FIG. 16 illustrates the operation when detecting the position of the medium S. When detecting the position of the medium S, the carriage 41, as shown in FIG. 16A, moves toward the medium S in the arrow A direction in the drawing. At this time, the light-emitting section 504 of the reflective optical sensor 502 emits light toward the platen 14, and the light that is reflected by the platen 14 is received by the light-receiving section 506 of the reflective optical sensor 502. Next, as shown in FIG. 16B, when the reflective optical sensor 502 provided in the carriage 41 is above one of the edges of the medium S, the light that is emitted from the light-emitting section 504 of the reflective optical sensor 502 is reflected by the medium S and this reflected light is received by the light-receiving section 506 of the reflective optical sensor 502.

When the light-receiving section 506 receives the light reflected by the medium S, there is a large change in the level of the signal that is output from the reflective optical sensor 502, and thus the position of the one edge of the medium S can be detected. Then, as shown in FIG. 16C, the carriage 41 is moved further in the arrow A direction, and when the reflective optical sensor 502 provided in the carriage 41 comes above the other edge of the medium S, the light that is emitted from the light-emitting section 504 of the reflective optical sensor 502 is reflected by the platen 14 and this reflected light is received by the light-receiving section 506 of the reflective optical sensor 502. At this time, there is another large change in the level of the signal that is output from the reflective optical sensor 502, and this allows the position of the other edge of the medium S to be detected. Then, as shown in FIG. 16D, the carriage 41 is further moved up to a predetermined position and the process of detecting the medium S is ended.

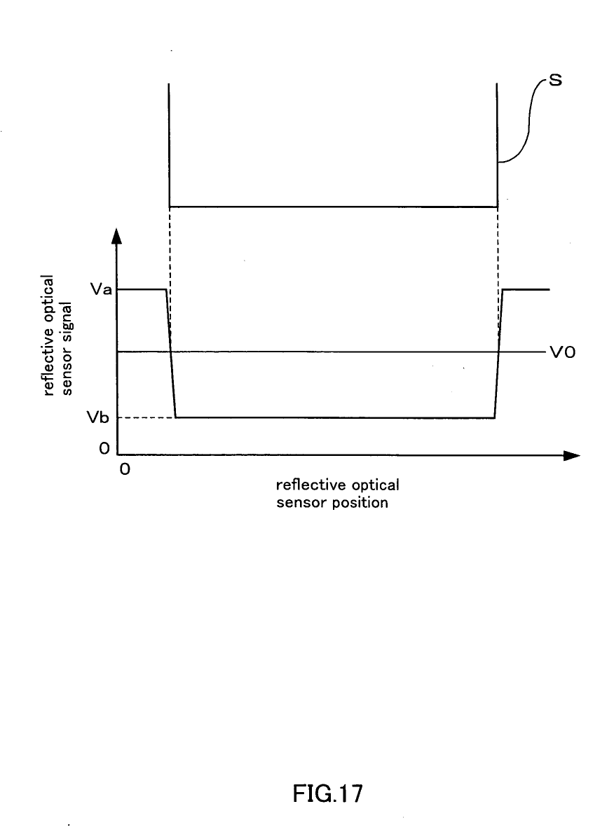

FIG. 17 summarizes the relationship between the level of the signal output from the reflective optical sensor 502 and the medium S. When the carriage 41 is moved and the reflective optical sensor 502 approaches one edge of the medium S, there is a large change in the level of the signal that is output from the reflective optical sensor 502 from the high level Va to the lower level Vb as shown in the drawing. Signals at the low level Vb are output from the reflective optical sensor 502 while the reflective optical sensor 502 is positioned above the medium S. When the reflective optical sensor 502 approaches the other edge of the medium S, the level of the signal that is output from the reflective optical sensor 502 reverts from the low level Vb back to the high level Va as shown in the drawing.

The system controller 126 consecutively obtains digital data corresponding to the level of the signal output from the reflective optical sensor 502 through the reflective optical sensor controller 508. The system controller 126 then consecutively compares the digital data obtained from the reflective optical sensor 502 with a predetermined threshold value V0 as shown in FIG. 17 to check whether or not the level of the signal output from the reflective optical sensor 502 exceeds the predetermined threshold value V0. Here, the predetermined threshold value V0 is set to an appropriate value between the high level Va and the low level Vb. If the level of the signal that is output from the reflective optical sensor 502 exceeds that predetermined threshold value V0, then it is determined that the one edge of the medium S has been detected by the reflective optical sensor 502, and the position of the edge of the medium S is specified based on the information output from the linear encoder 51 and this position is stored in the main memory 127, for example.

The system controller 126 then continues to compare the digital data obtained from the reflective optical sensor 502 with the predetermined threshold value V0 to check whether or not the level of the signal from the reflective optical sensor 502 again exceeds the predetermined threshold value V0. If the level of the signal output from the reflective optical sensor 502 again exceeds the predetermined threshold value V0, then it is determined that the other edge of the medium S has been detected by the reflective optical sensor 502, and the position of the other edge of the medium S is specified based on the output information of the linear encoder 51 and this position is stored in the main memory 127, for example. In this way, the positions of both edges of the medium S are specified, which allows the position of the medium S to be detected as well as allows the width of the medium S to be detected, and from the width, it is possible to specify the size, for example, of the medium S.

===Inspection of the Platen 14===

With the inkjet printer 1 of the present embodiment, the condition of the platen 14 is inspected. The process of inspecting the platen 14 that is executed here is described in detail below.

<Reason for Inspection>

The condition of the platen 14 is inspected for the following reason. With printing apparatuses such as the inkjet printer 1 of the present embodiment in which ink is ejected onto a medium S to perform printing, there is the problem that ink that has been ejected becomes a spray-like mist that dirties the platen 14 and the surrounding area. In particular, when “borderless printing” is executed, some of the ink that is ejected from the nozzles #1 to #180 does not arrive at the medium S and instead lands outside of the medium S, and thus mist can occur easily and the degree of dirtying of the platen 14 also is large.

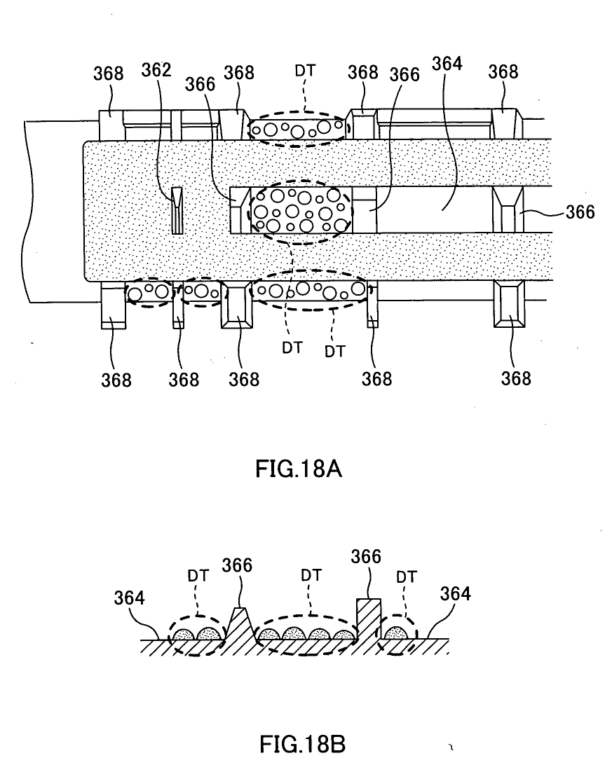

FIG. 18 describes a state in which the platen 14 has become dirty. FIG. 18A is a plan view showing an example of how the platen 14 becomes dirty, and FIG. 18B is a sectional view of that dirty area. As shown in FIG. 18A, the spray-like ink that has been ejected from the nozzles #1 to #180 has adhered to the periphery of the groove section 354 and the upper surface of the rectangular protruding sections 364 within the groove section 354, for example, forming globular blots DT. The globular blots DT are created by mist-like ink accumulating and gradually growing like a crystal, and as shown in FIG. 18B, they bulge upward like a hill on the upper surface of the periphery of the groove section 354 and the upper surface of the rectangular protruding sections 364 within the groove section 354.

It should be noted that if mist-like ink lands in the groove section 354, that is, reaches the absorbing material 356, then it is absorbed by the absorbing material 356, and if it has adhered to the projecting sections 362 or the ribs 366 or 368, then it adheres and is removed by the medium S being printed.

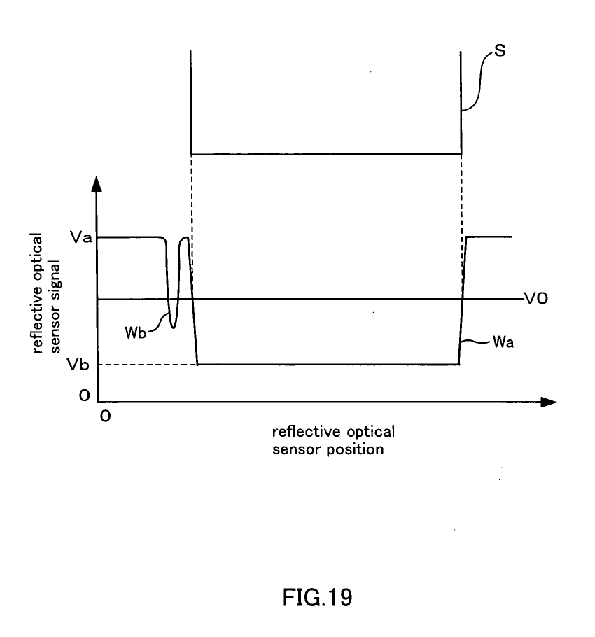

If the platen 14 is dirtied in this way, then when the medium S is detected by the reflective optical sensor 502, a blot DT on the platen 14 may be mistakenly detected as the medium S. FIG. 19 shows an example of a signal that is output from the reflective optical sensor 502 when the platen 14 is dirty. When the platen 14 has become dirty, then as shown in the drawing, the signal that is output from the reflective optical sensor 502 includes a rectangular pulse Wa indicating that the medium S has been detected as well as a spiked pulse Wb that occurs when a blot DT has been detected. There are instances in which the spiked pulse Wb may exceed the predetermined threshold value V0, which serves as a reference for medium S detection. If a pulse Wb occurs that exceeds the predetermined threshold value V0, then the blot DT on the platen 14 may be recognized as a portion of the medium S, resulting in misdetection of the position of the medium S.

<Inspection Method>

Accordingly, in order to eliminate misdetection of the medium S due to such blots DT on the platen 14, in the inkjet printer 1 of this embodiment, the condition of the platen 14 is inspected at a suitable timing, and based on the results of this inspection, the predetermined threshold value V0 is suitably changed. The process for changing the predetermined threshold value V0 is described in detail below.

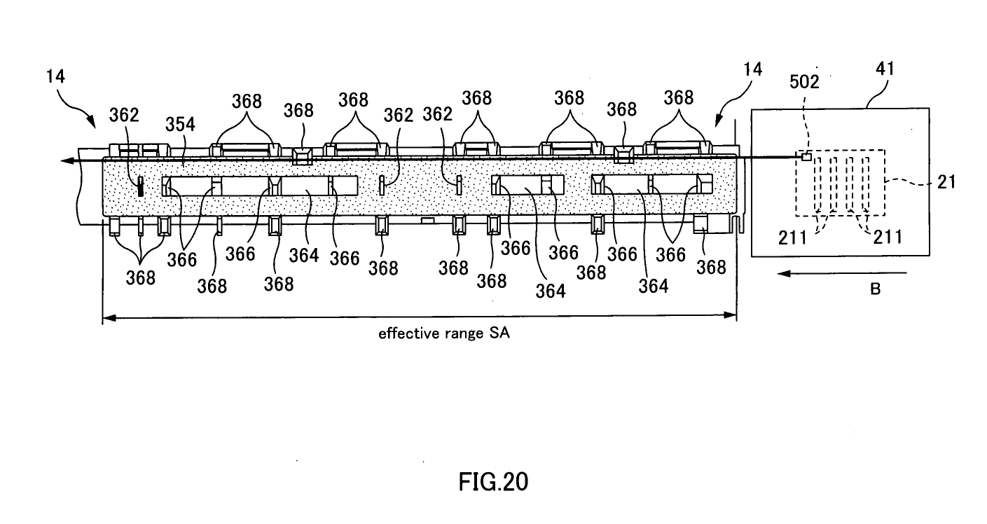

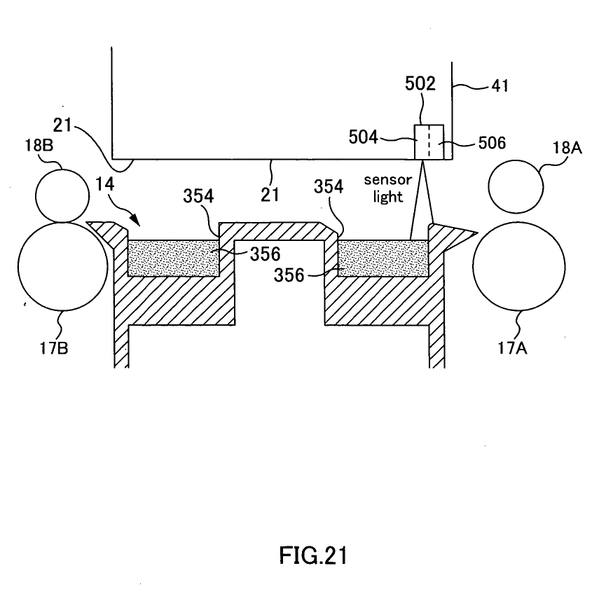

FIG. 20 and FIG. 21 illustrate how the platen 14 is inspected. FIG. 20 is a plan view illustrating a state in which the platen 14 is being inspected. FIG. 21 is a lateral view illustrating a state in which the platen 14 is being inspected.

Inspection of the platen 14 is performed by the reflective optical sensor 502 when a medium S is not on the platen 14. When inspecting the platen 14, as shown in FIG. 20, the carriage 41 on which the reflective optical sensor 502 is provided is moved over the platen 14 in the direction of the arrow B in the drawing. At this time, the light-emitting section 504 of the reflective optical sensor 502 emits light toward the platen 14 as shown in FIG. 21. Here, the light that is emitted is irradiated spanning over the groove section 354 (absorbing material 356) in the platen 14 and its edge portions. The light that is emitted from the light-emitting section 504 is reflected by the groove section 354 in the platen 14 or its edge portions, and this reflected light is received by the light-receiving section 506 of the reflective optical sensor 502. Light is continuously emitted by the light-emitting section 504 and received by the light-receiving section 506 while the carriage 41 is moving over the platen 14.

The reflective optical sensor 502 generates signals corresponding to the intensity of the light that is received by the light-receiving section 506 and outputs these to the reflective optical sensor controller 508 (see FIG. 4). The reflective optical sensor controller 508 samples the signals from the reflective optical sensor 502 at a predetermined period, converts the signals from analog signals to digital signals with the A/D conversion section 510, and outputs these to the system controller 126 as digital data. The system controller 126 obtains the digital data from the reflective optical sensor 502 and obtains data corresponding to the effective range SA shown in FIG. 20 as the inspection results. The system controller 126 then determines whether or not it is necessary to change the predetermined threshold value V0, which serves as a reference for detection of the medium S, based on the inspection results, and if the predetermined threshold value V0 is to be changed, then it determines the value to which the predetermined threshold value V0 should be changed.

<Changing the Threshold Value>

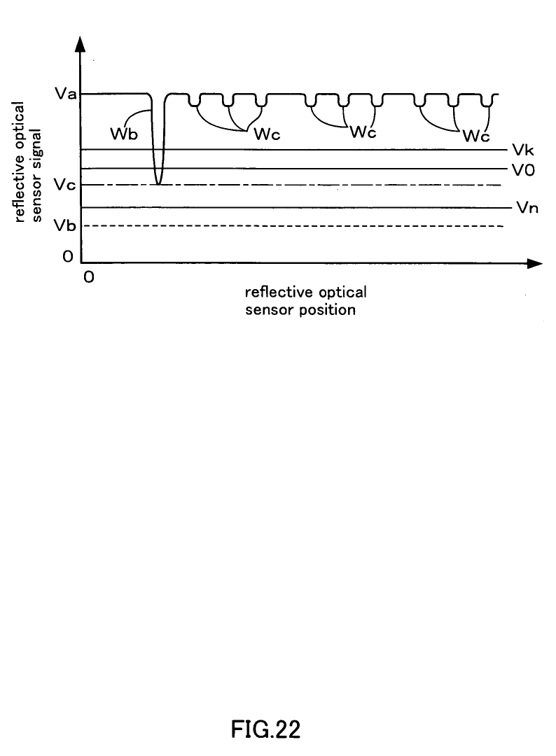

FIG. 22 shows an example of the signal that is output from the reflective optical sensor 502 when the platen 14 surface has been inspected by the reflective optical sensor 502. If there are blots DT on the platen 14, then as shown in FIG. 22, a spiked pulse Wb will occur in the signal that is output from reflective optical sensor 502. It should be noted that the pulses Wc present in the signal that is output from the reflective optical sensor shown in the drawing occur due to the light-receiving section receiving light reflected by the ribs 368 in the periphery of the groove section 354 of the platen 14.

The system controller 126 obtains a minimum value Vc from the signal output from the reflective optical sensor 502 and finds the amplitude of the spiked pulse Wb that occurs when there is a blot DT on the platen 14. The system controller 126 then checks whether or not the minimum value Vc that has been obtained is greater than a predetermined reference value Vk. If the minimum value Vc that has been obtained is greater than a predetermined reference value Vk, then the system controller 126 determines that it is necessary to change the threshold value V0, which until then had served as the reference for detection of the medium S, and sets a new threshold value Vn between the minimum value Vc that has been obtained and the signal level Vb obtained due to detection of the medium S during medium detection. The new threshold value Vn that is set here can be set exactly in the middle between the minimum value Vc that has been obtained and the signal level Vb that is obtained from the medium S at the time of medium detection, or it can be a value that is closer to either the signal level Vb or the minimum value Vc. The new threshold value Vn that is set here is stored on the main memory 127, for example, by the system controller 126.

The next time that detection of the medium S is performed, detection of the medium S can be performed using the newly set threshold value Vn. This prevents a blot DT, for example, from being erroneously detected as the medium S even when there are blots DT or the like on the platen 14. Thus, the medium S can be detected with higher accuracy than in conventional cases where the predetermined threshold value V0 is set as a fixed value.

It should be noted that, here, the signal level Vb that is obtained by detection of the medium S during detection of the medium S can be a signal level that is obtained from a specific type of medium, such as normal paper, or alternatively can be an average value obtained from a plurality of types of media or a value (which is the maximum value in this case) obtained from a medium that is closest to the threshold value V0.

<Procedure of the Inspection Process>

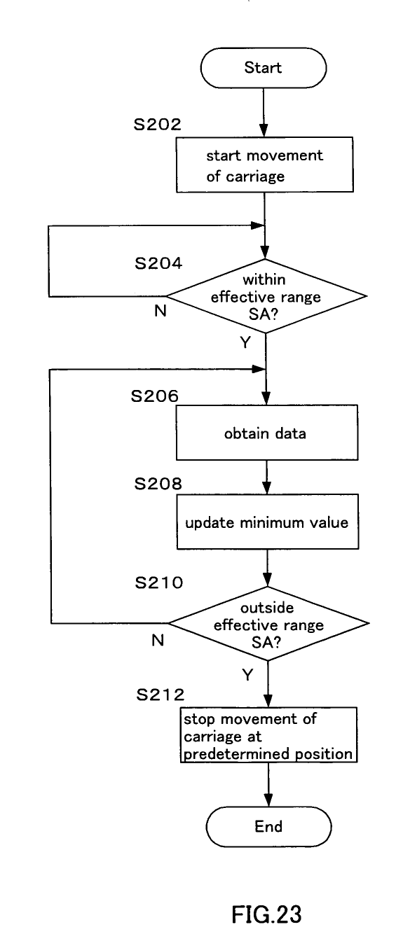

FIG. 23 is a flowchart showing an example of the procedure of the processing when inspecting the platen 14. When performing inspection of the platen 14, the system controller 126 first drives the carriage motor 42 via the carriage motor controller 128 to start movement of the carriage 41 (S202). As a result, the carriage 41 starts moving in the arrow B direction as shown in FIG. 20, for example. It should be noted that the light-emitting section 504 of the reflective optical sensor 502 emits light from the start of moving the carriage 41.

The system controller 126, in tandem with the start of moving the carriage 41, successively checks whether or not the current position of the reflective optical sensor 502 provided in the carriage 41 is within a predetermined effective range SA based on the current position of the carriage 41, which is obtained from the linear encoder 51 (S204). Then, when the reflective optical sensor 502 is within the predetermined effective range SA, the system controller 126 obtains from the reflective optical sensor controller 508 the data regarding the signal output from the reflective optical sensor 502 (S206) and determines whether or not this data is a minimum value (S208). If the data obtained from the reflective optical sensor controller 508 is the minimum value, then the system controller 126 successively stores that minimum value in the main memory 127, for example.

Next, the system controller 126 determines whether or not the current position of the reflective optical sensor 502 has deviated from the predetermined effective range SA based on the current position of the carriage 41, which is obtained from the linear encoder 51 (S210). Here, if the current position of the reflective optical sensor 502 is still within the predetermined effective range SA, then the system controller 126 returns to step S206 and again obtains data from the reflective optical sensor controller 508 and checks whether or not this data is a minimum value (S208). The steps of obtaining data (S206) and determining whether or not that data is a minimum value (S208) are performed continuously by the system controller 126 until the current position of the reflective optical sensor 502 has left the predetermined effective range SA.

Here, if in step S210 it is determined that the current position of the reflective optical sensor 502 is outside the predetermined effective range SA, then the system controller 126 stops the carriage 41 at a predetermined position. Thus, the process of inspecting the platen 14 is ended.

<Procedure of Changing the Threshold Value>

The procedure of the processing when changing the predetermined threshold value V0 based on the minimum value Vc that is obtained by inspecting the platen 14 in this manner is described next.

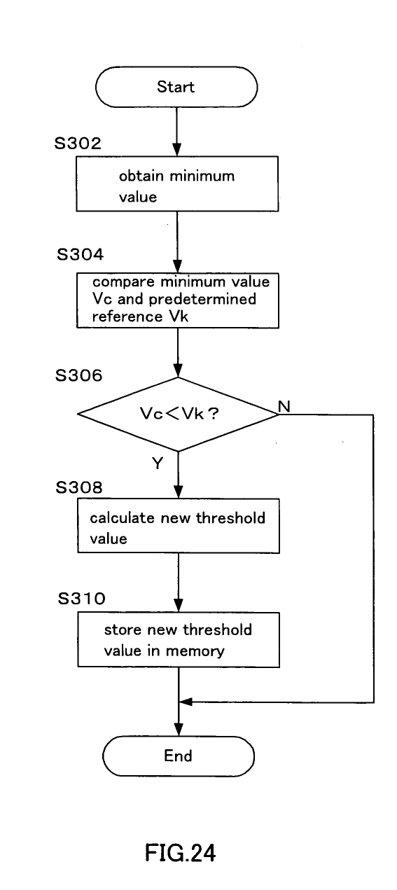

FIG. 24 is a flowchart showing the flow of the processing performed when changing the predetermined threshold value V0. The system controller 126 obtains the minimum value Vc that has resulted from inspection of the platen 14 (S302) and compares the minimum value Vc that has been obtained with a predetermined reference value Vk (S304). The system controller 126 then determines whether or not the minimum value Vc that has been obtained is below the predetermined reference value Vk (S306). If the minimum value Vc that has been obtained is not below the predetermined reference value Vk, then the system controller 126 determines that it is not necessary to change the threshold value V0 and immediately ends the procedure. On the other hand, if the minimum value Vc that has been obtained is below the predetermined reference value Vk, then the system controller 126 determines that it is necessary to change the threshold value V0 and calculates a new threshold value Vn that is set between the minimum value Vc that has been obtained and the signal level Vb that is obtained as the result of detecting the medium S during medium detection (see FIG. 22) (S308).

The system controller 126 then replaces the original threshold value V0 with the new threshold value Vn that has been calculated and stores this in the main memory 127 for example (S310), so that the new threshold value Vn is used when the next medium-detection process is performed.

It should be noted that in the above embodiment, the predetermined threshold value V0 is changed based on a minimum value Vc, but if the level of the signal that is output from the reflective optical sensor is plus-minus inverted, then it is also possible to obtain a maximum value from this signal and to change the predetermined threshold value V0 based on that maximum value.

===Sampling Period===

With the inkjet printer 1 according to this embodiment, the period of the sampling performed by the A/D conversion section 510 when detecting the medium S during printing and the period of the sampling performed by the A/D conversion section 510 when inspecting the platen 14 are different. Specifically, the period of the sampling performed by the A/D conversion section 510 when inspecting the platen 14 is set shorter than the period of the sampling performed by the A/D conversion section 510 when detecting the medium S during printing.

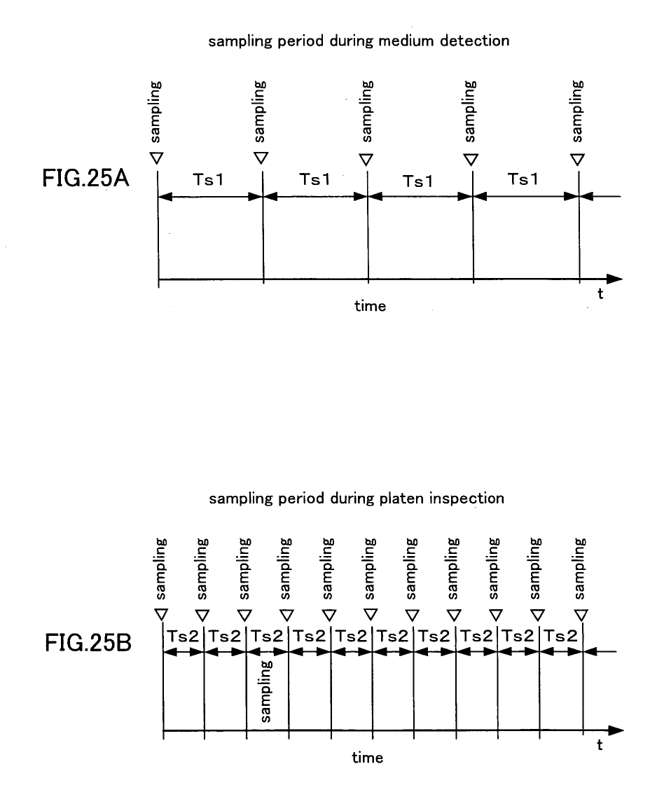

FIG. 25 shows the respective periods of the sampling performed by the A/D conversion section 510. FIG. 25A shows the period of the sampling performed by the A/D conversion section 510 when detecting the medium S during printing, and FIG. 25B shows the period of the sampling performed by the A/D conversion section 510 when inspecting the platen 14.

When detecting the medium S during printing, as shown in FIG. 25A the A/D conversion section 510 samples the signals output from the reflective optical sensor 502 at a period Ts1. On the other hand, when inspecting the platen 14, as shown in FIG. 25B the A/D conversion section 510 samples the signals output from the reflective optical sensor 502 at a period Ts2, which is shorter than the period Ts1. It should be noted that the white inverted triangles (V) in FIG. 25A and FIG. 25B indicate the points where sampling is performed.

The following discusses the reason why it is possible to differ the period of the sampling performed by the A/D conversion section 510 when detecting the medium S during printing and the period of the sampling performed by the A/D conversion section 510 when inspecting the platen 14 in this manner. In the case of detecting the medium S during printing, it is necessary for the system controller 126 to sequentially process the print data that are sent from the host computer 140, and this significantly increases the process load of the system controller 126. As a result, the system controller 126 cannot allocate a large amount of ability for processing the data of the signals from the reflective optical sensor 502 that it receives through the reflective optical sensor controller 508. Consequently, it is forced to process the data of the signals from the reflective optical sensor 502, which it receives through the reflective optical sensor controller 508, at an extremely limited processing ability. In light of this limitation, it is difficult to set a short period for the sampling that is performed by the A/D conversion section 510 when detecting the medium S during printing.

In contrast, when inspecting the platen 14, the system controller 126 is not processing print data from the host computer 140, and thus can smoothly process the data that are sent from the A/D conversion section 510. As a result, the period of the sampling that is performed by the A/D conversion section 510 when inspecting the platen 14 can be made short.

It should be noted that the period of the sampling performed by the A/D conversion section 510 is changed by the reflective optical sensor controller 508 in accordance with a command from the system controller 126.

Setting the period of the sampling that is performed by the A/D conversion section 510 when inspecting the platen 14 shorter than the period of the sampling performed by the A/D conversion section 510 when detecting the medium S during printing has the following advantages.

(A) The Time for Inspection of the Platen 14 can be Reduced.

When inspecting the platen 14, the period of the sampling performed by the A/D conversion section 510 can be set short, and thus the movement velocity of the carriage 41, that is, the movement velocity of the reflective optical sensor 502 can be increased, allowing the time required for inspection of the platen 14 to be significantly reduced. In other words, for an identical number of sampling processes, the processing time required for inspection of the platen 14 will be shorter than that for the detection of the medium S during printing.

(B) Inspection of the Platen 14 can be Executed with High Accuracy.

When inspecting the platen 14, the period for the sampling that is performed by the A/D conversion section 510 can be set short, and thus as long as there is no change in the movement velocity of the carriage 41, that is, the movement velocity of the reflective optical sensor 502, inspection of the platen 14 can be executed with higher accuracy. In other words, the condition of the platen 14 can be inspected in greater detail because the sampling interval on the platen 14 is short. Thus, even small blots DT on the platen 14 can be detected.

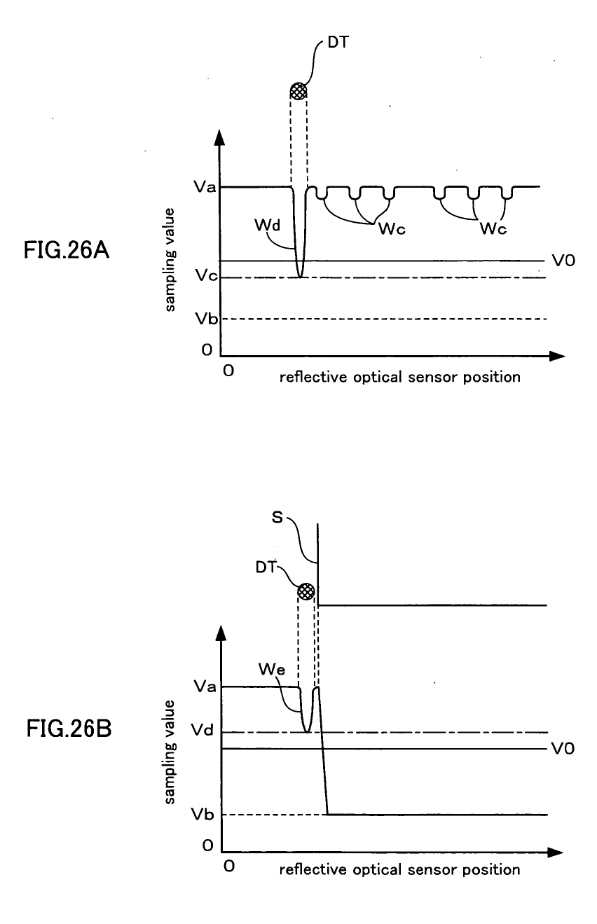

FIG. 26A illustrates the results of sampling obtained when the condition of the platen 14 is closely examined by setting a short period for the sampling performed by the A/D conversion section 510. If the A/D conversion section 510 performs sampling at a shorter period, then as shown in this figure, even small blots DT that have occurred on the platen 14 can be detected as a spiked pulse Wd, which has a large amplitude. As a result, the predetermined threshold value V0, which as discussed above serves as the reference for determining whether or not the medium S is present, can be changed based on the spiked pulse Wd. This permits early discovery of even small blots DT, for example, that have occurred on the platen 14 and allows the predetermined threshold value V0 to be changed at an early stage in accordance with that blot DT, thereby allowing misdetection of the medium S due to the presence of a blot DT on the platen 14 to be prevented in advance.

On the other hand, when detecting the medium S during printing, sampling performed by the A/D conversion section 510 is carried out at a longer period than that when inspecting the platen 14, and thus the sampling interval is wider than that during inspection of the platen 14, and this does not permit close examination of the condition of the platen 14. Thus, small blots DT that have occurred on the platen 14 are not detected like when performing inspection of the platen 14.

FIG. 26B illustrates the results of sampling in a case where sampling is executed at a long period when detecting the medium during printing. If sampling is performed at a longer period when detecting the medium S during printing than during inspection of the platen 14, then as shown in FIG. 26B, the small blot DT on the platen 14 is detected as a pulse We that has a smaller amplitude than the large-amplitude pulse Wd that is obtained when inspecting the platen 14 (see FIG. 26A). Consequently, this small-amplitude pulse We is not determined to be the medium S when determining whether or not the medium S is present.

As described above, small blots DT that cannot be detected when detecting the medium S during printing can be detected in advance when performing inspection of the platen 14 because inspection of the platen 14 is performed by sampling at a shorter period than when detecting the medium S during printing. Moreover, if the predetermined threshold value V0 can be changed at an earlier timing in accordance with that small blot DT, then misdetection of that small blot DT as the medium S when performing detection of the medium S during printing can be prevented even more reliably.

With the inkjet printer 1 according to the foregoing embodiment, the time required for inspection of the platen 14 can be reduced by setting a shorter period for the sampling that is executed when inspecting the platen 14 than the period of the sampling that is executed when performing detection of the medium S during printing. Further, small blots DT, for example, on the platen 14 can be found with accuracy in advance as the result of executing high accuracy inspection of the platen 14 and the predetermined threshold value V0 can be changed at an earlier timing in accordance with that small blot DT, and therefore it becomes possible to sufficiently prevent misdetection of the medium S when performing detection of the medium S during printing.

===Inspection Timing===

The following (A) to (E), for example, are examples of timings to perform inspection of the platen 14.

(A) When the Power is Turned On

When the inkjet printer 1 is powered up, the condition of the platen 14 is inspected, as one of the initializing processes, to check whether or not it is necessary to reset the predetermined threshold value V0.

(B) Prior to a Print Job

When the inkjet printer 1 has received print data from the host computer 140, the condition of the platen 14 is inspected to check whether or not it is necessary to reset the predetermined threshold value V0 before performing printing based on those print data.

(C) During a Print Job

After performing printing based on print data that have been sent from the host computer 140, the condition of the platen 14 is inspected to determine whether or not it is necessary to reset the predetermined threshold value V0 before the next print data is sent from the host computer 140 and printing is performed based on those print data.

(D) Per Page

Each time that a sheet of the medium S is supplied from the paper supply section 4, the condition of the platen 14 is inspected to determine whether or not it is necessary to reset the predetermined threshold value V0.

(E) First Execution of Borderless Printing

The first time that the inkjet printer 1 executes “borderless printing,” the condition of the platen 14 is inspected and the predetermined threshold value V0 is set accordingly. Determination regarding whether or not “borderless printing” is going to be executed for the first time by the inkjet printer 1 is made based on information stored on a suitable memory section in the inkjet printer 1, such as the main memory 127. That is, for example, execution history information about whether or not the inkjet printer 1 has executed “borderless printing” before is stored on a suitable memory section such as the main memory 127. When the inkjet printer 1 is shipped as a product, information indicating that “borderless printing” has not yet been executed is stored on the main memory 127, for example, as execution history information. When “borderless printing” is executed, the execution history information is changed by the system controller 126.

When “borderless printing” is executed, the system controller 126 checks the execution history information stored on the main memory 127, for example. The system controller 126 then determines whether or not “borderless printing” will be executed for the first time. If it is determined here that “borderless printing” will be executed for the first time, then the system controller 126 causes light to be emitted from the light-emitting section 504 of the reflective optical sensor 502 to inspect the condition of the platen 14. The predetermined threshold value V0 is then suitably set based on the results of that inspection.

It should be noted that in the present invention it is not absolutely necessary to execute inspection at the above timings (A) to (E), and it is also possible to perform inspection of the platen 14 at timings other than those of (A) to (E).

===Configuration of Printing System, etc.===

The following is a description of an example printing system provided with an inkjet printer as a printing apparatus, as one example of a printing system according to the present invention.

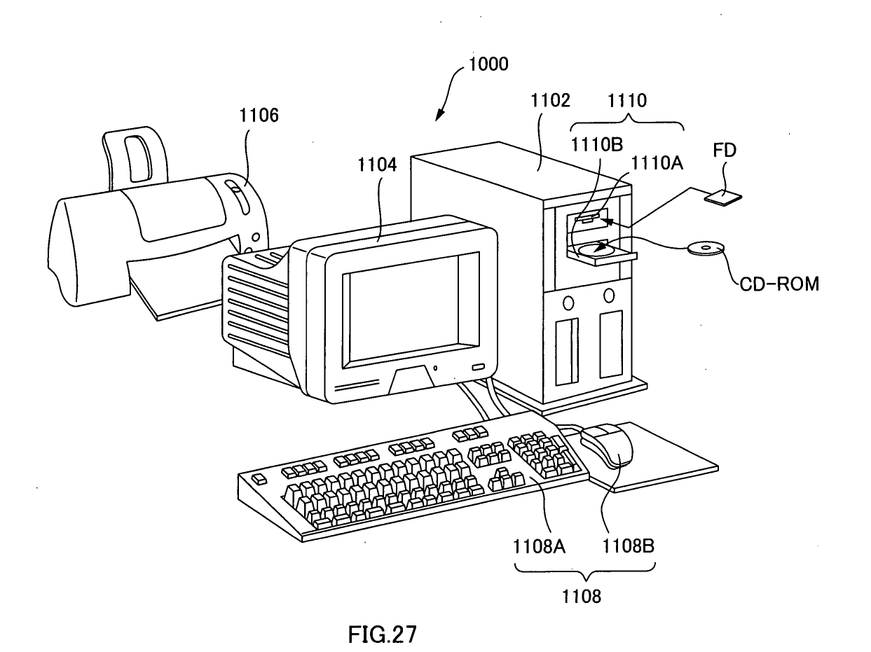

FIG. 27 is an explanatory diagram showing the external structure of the printing system. A printing system 1000 is provided with a main computer unit 1102, a display device 1104, a printing apparatus 1106 such as the inkjet printer 1, an input device 1108, and a reading device 1110. In this embodiment, the main computer unit 1102 is accommodated within a mini-tower type housing, but this is not a limitation. A CRT (cathode ray tube), plasma display, or liquid crystal display device, for example, is generally used as the display device 1104, but there is no limitation to this. The printing apparatus 1106 is the printer described above. In this embodiment, the input device 1108 is a keyboard 1108A and a mouse 1108B, but there is no limitation to these. In this embodiment, the reading device 1110 is a flexible disk drive device 1110A and a CD-ROM drive device 1110B, but there is no limitation to these, and the reading device 1110 may also be a MO (magnet optical) disk drive device or a DVD (digital versatile disk), for example.

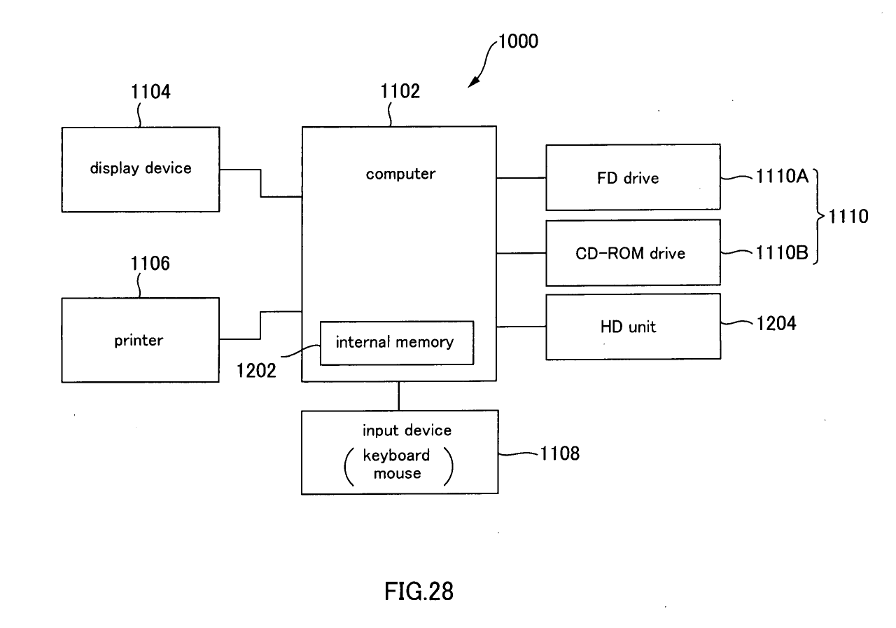

FIG. 28 is a block diagram showing the configuration of the printing system shown in FIG. 27. The system is further provided with an internal memory 1202 such as a RAM provided inside the housing in which the main computer unit 1102 is accommodated, as well as an external memory such as a hard disk drive unit 1204.

A computer program for controlling the operation of the above-described inkjet printer 1 can be downloaded onto a computer 1000, for example, connected to the printing apparatus 1106 via a communications line such as the Internet, and it can also be stored on a computer-readable storage medium and distributed, for example. Various types of storage media can be used as this storage medium, including flexible disks FDs, CD-ROMs, DVD-ROMs, magneto optical disks MOs, hard disks, and memories. It should be noted that information stored on such storage media can be read by various types of reading devices 1110.

It should be noted that the above description illustrates an example in which the printing system is constituted by connecting the printing apparatus 1106 to the main computer unit 1102, the display device 1104, the input device 1108, and the reading device 1110, but there is no limitation to this. For example, the printing system can be made of the main computer unit 1102 and the printing apparatus 1106, and the printing system does not have to be provided with any of the display device 1104, the input device 1108, and the reading device 1110. It is also possible for the printing apparatus 1106 to have some of the functions or mechanisms of the main computer unit 1102, the display device 1104, the input device 1108, and the reading device 1110. For example, the printing apparatus 1106 may be structured having an image processing section for carrying out image processing, a display section for carrying out various types of displays, and a recording media attachment/detachment section to and from which recording media storing image data captured by digital camera or the like are inserted and taken out.

An overall printing system thus achieved is superior to conventional systems.

### Other Embodiments

A printing apparatus such as a printer according to the present invention was described above through one implementation thereof, but the foregoing embodiment is for the purpose of elucidating the present invention and is not to be interpreted as limiting the present invention. The invention can of course be altered and improved without departing from the gist thereof and includes equivalents. In particular, the implementations discussed below also are included in printing apparatus according to the invention.

Further, in the foregoing embodiment, some or all of the structures achieved by hardware can be replaced by software, and conversely, some of the structures that are achieved by software can be replaced by hardware.

Furthermore, some of the processes performed on the printing apparatus side can be executed on the host side, and it is also possible to provide a dedicated processing device between the printing apparatus and the host, and to make this processing device execute some of the processes.

<Regarding the Ink>

Pigment ink or dye ink, for example, may be used as the ink to be ejected from the “ink ejecting section (printing section)”. Further, transparent clear ink may be used. That is, the ink used for the present invention includes any type of liquid as long as it can be ejected toward a medium.

<Regarding the Ink Ejecting Section>

In the foregoing embodiment, the “ink ejecting section” was described as including the nozzle rows 211 as shown in FIG. 5. The ink-ejecting section, however, does not necessarily have to be a nozzle row, and it may be any type of ink ejecting section as long as it can eject ink toward a medium.

Further, in the foregoing embodiment, the “ink ejecting section” was described as having nozzle rows of the various colors yellow (Y), magenta (M), cyan (C), and black (K). The ink ejecting section, however, is not limited to ink-ejecting sections that eject inks of the above-mentioned colors, but includes ink-ejecting sections that eject inks of other colors, such as light magenta (LM), light cyan (LC), dark yellow (DY), blue, red, and violet.

<Regarding the Printing Section>

In the foregoing embodiment, nozzles #1 to #180 that eject ink are provided in the head 21 as shown in FIG. 5 as an example of the “printing section”, but the printing section can also be a printing section that is provided with ink ejecting sections other than nozzles #1 to #180 for ejecting ink, and alternatively it can also be a printing section that prints on media through a method other than ejecting ink. For example, the “printing section” also includes printing sections that print on media through various other methods, including those that print on media through a dot impact method, those that print on media through a laser beam method, and those that employ a thermal transfer method or a sublimation method.

<Regarding the Supporting Section (Support Member)>

In the foregoing embodiment, a platen 14 such as that shown in FIGS. 11 to 13 was described as an example of the “supporting section (support member)”, but the supporting section (support member) is not limited to such a platen 14, and any portion (member) that supports the medium S being printed is within the scope of the supporting section (support member) of the present invention.

<Regarding the Ink Collecting Section>

In the foregoing embodiment, the groove section 354 was provided in the support member (platen 14) as the “ink collecting section”, as shown in FIGS. 11 through 13. The ink ejecting section, however, is not limited to such a groove section 354, and any type of ink collecting section may be adopted as long as it can collect ink that has been ejected from the ink ejecting section (nozzle row 211) and landed outside of the medium.

<Regarding the Optical Sensor>

In the foregoing embodiment, a reflective optical sensor 502 such as that discussed above was described as an example of the “optical sensor”, but the optical sensor is not limited to such a reflective optical sensor, and any sensor will do as long as it emits light toward the medium S and detects the light that is reflected by the medium S.

Further, the reflective optical sensor 502 described as an example of the “optical sensor” in the foregoing embodiment was disposed on the carriage 41 and was capable of relative movement with respect to the medium S or the platen (supporting section, support member) 14, but the optical sensor does not necessarily have to be provided in such a manner that it can move relative to the medium S or the platen (supporting section, support member) 14, and it is not absolutely necessary that it be disposed on the carriage 41.

<Signals Generated by (Output from) the Optical Sensor>

The signals generated by the reflective optical sensor 502 as the “optical sensor” were analog signals in the foregoing embodiment, but it is also possible for the signals generated by the optical sensor to be digital signals, for example, rather than analog signals.

<Regarding Detection of the Medium>

In the foregoing embodiment, the reflective optical sensor 502 was provided on the carriage 41 as the “optical sensor”, and by moving the carriage 41 it was possible to detect the edge positions, the width, and the size of the medium S, but detection of the medium by the optical sensor is not limited to such detection, and as long as detection of the medium can be performed, such as detection of whether or not the medium is present, the manner in which detection of the medium is performed is immaterial.

<Regarding Sampling>.

In the foregoing embodiment, the sampling executed in order to detect the medium during printing and the sampling executed when inspecting the platen were both performed by the same controller (the system controller 126), but the invention is not limited to such an implementation, and it is also possible for these sampling processes to be executed by separate controllers.

<Regarding the Movement Range>

In the foregoing embodiment, the range over which the optical sensor (the reflective optical sensor 502) is moved with respect to the supporting section (support member) (the platen 14) when changing the threshold value spanned over the entire supporting section (support member), but it is not always necessary that the movement range of the optical sensor spans the entire supporting section (support member) in this manner, and it can also be only a portion of the supporting section (support member).

<Regarding the Printing Apparatus>

In the foregoing embodiment, an inkjet printer was described as the printing apparatus according to the invention, but the printing apparatus of the invention is not limited to such a printing apparatus, and it may be any type of printing apparatus, such as a dot impact-type printer or a laser beam-type printer, so long as it is an apparatus that executes printing with respect to a medium.

<Regarding the Medium>

As regards the medium, it is possible to use normal paper, matte paper, cut paper, glossy paper, roll paper, sheet paper, photographic paper, and rolled photographic paper, for example, as the medium, and in addition to these, it is also possible to use film material such as OHP film or glossy film, cloth material, and sheet metal material. In other words, any medium may be used as long as ink can be ejected onto it.

<Regarding the Printing System>

In the foregoing embodiment, a structure in which an inkjet printer is connected to a main computer unit is described as the printing system of the invention, but in the printing system of the invention, the printing apparatus that is connected to the main computer unit is not limited to an inkjet printer, and it can be other types of printing apparatuses as well. As long as the apparatus executes printing with respect to a medium, the type of the printing apparatus is immaterial, and for example it can also be a dot impact-type printer or a laser beam-type printer.

In the foregoing embodiment, a structure provided with a display device 1104, an input device 1108, and a reading device 1110, in addition to the main computer unit 1102, was described as an example of the printing system, but the printing system according to the invention does not necessarily have to be furnished with this structure, and it is only necessary that the printing system is provided with the main computer unit 1102 in addition to the printing apparatus.

1. A printing method comprising the steps of:
emitting light from a light-emitting section of an optical sensor toward a support member for supporting a medium, said support member being provided with an ink collecting section for collecting ink that has been ejected from an ink ejecting section and that has landed outside of said medium;
changing a threshold value based on a signal that is output from said optical sensor in correspondence with an intensity of light reflected by said support member and received by a light-receiving section of said optical sensor; and
detecting the medium by comparing the signal that is output from said optical sensor and the threshold value that has been changed.

2. A printing method according to claim 1,
wherein said optical sensor is provided to be movable relative to said support member.

3. A printing method according to claim 2,
wherein when said optical sensor is moved relative to said support member, said medium is detected by comparing said signal that is output from said optical sensor with said threshold value.

4. A printing method according to claim 2,
wherein when said optical sensor is moved relative to said support member, said threshold value is changed based on said signal that is output from said optical sensor.

5. A printing method according to claim 4,
wherein a range over which said optical sensor moves relative to said support member when changing said threshold value spans over the entire support member.

6. A printing method according to claim 4,
wherein a range over which said optical sensor moves relative to said support member when changing said threshold value is equal to a range over which said optical sensor moves relative to said support member when detecting said medium.

7. A printing method according to claim 1,
wherein said threshold value is changed based on a value obtained by sampling, at a predetermined period, said signal that is output from said optical sensor.

8. A printing method according to claim 1,
wherein a minimum value or a maximum value is obtained from said signal that is output from said optical sensor, and said threshold value is changed based on said minimum value or said maximum value.

9. A printing method according to claim 8,
wherein said threshold value is not changed when said minimum value or said maximum value does not reach a predetermined reference value.

10. A printing method according to claim 1,
wherein when changing said threshold value, light is emitted from said light-emitting section toward said ink collecting section.

11. A printing method according to claim 1,
wherein said ink collecting section is formed as a groove section in said support member.

12. A printing method according to claim 1,
wherein when changing said threshold value, light that is received by said light-receiving section includes light that has been reflected by a recessed/projecting section provided in said support member.

13. A printing method according to claim 1,
wherein said threshold value is changed based on said signal that is output from said optical sensor when said ink is not being ejected toward said medium by said ink ejecting section.

14. A printing method according to claim 1,
wherein said ink ejecting section, said support member, said ink collecting section, and said optical sensor are provided in a printing apparatus; and
wherein said threshold value is changed based on said signal that is output from said optical sensor when power of said printing apparatus is turned on.

15. A printing method according to claim 1,
wherein an execution history of borderless printing, in which printing is carried out by ejecting ink toward an edge of the medium from said ink ejecting section, is stored on a memory; and
wherein when said borderless printing is executed, said execution history stored on said memory is checked, and if said borderless printing has not been executed before, then said threshold value is changed based on said signal that is output from said optical sensor when light is emitted from said light-emitting section toward said support member and the light that is reflected by said support member is received by said light-receiving section.

16. A printing method comprising the steps of:
emitting light from a light-emitting section of an optical sensor toward a support member for supporting a medium, said support member being provided with an ink collecting section for collecting ink that has been ejected from an ink ejecting section and that has landed outside of said medium;
changing a threshold value based on a signal that is output from said optical sensor in correspondence with an intensity of light reflected by said support member and received by a light-receiving section of said optical sensor; and
detecting the medium by comparing the signal that is output from said optical sensor and the threshold value that has been changed;
wherein said optical sensor is provided to be movable relative to said support member;
wherein when said optical sensor is moved relative to said support member, said medium is detected by comparing said signal that is output from said optical sensor with said threshold value;
wherein when said optical sensor is moved relative to said support member, said threshold value is changed based on said signal that is output from said optical sensor;
wherein a range over which said optical sensor moves relative to said support member when changing said threshold value spans over the entire support member;
wherein a range over which said optical sensor moves relative to said support member when changing said threshold value is equal to a range over which said optical sensor moves relative to said support member when detecting said medium;
wherein said threshold value is changed based on a value obtained by sampling, at a predetermined period, said signal that is output from said optical sensor;
wherein a minimum value or a maximum value is obtained from said signal that is output from said optical sensor, and said threshold value is changed based on said minimum value or said maximum value;
wherein said threshold value is not changed when said minimum value or said maximum value does not reach a predetermined reference value;
wherein when changing said threshold value, light is emitted from said light-emitting section toward said ink collecting section;
wherein said ink collecting section is formed as a groove section in said support member;
wherein when changing said threshold value, light that is received by said light-receiving section includes light that has been reflected by a recessed/projecting section provided in said support member;
wherein said threshold value is changed based on said signal that is output from said optical sensor when said ink is not being ejected toward said medium by said ink ejecting section;
wherein said ink ejecting section, said support member, said ink collecting section, and said optical sensor are provided in a printing apparatus;
wherein said threshold value is changed based on said signal that is output from said optical sensor when power of said printing apparatus is turned on;
wherein an execution history of borderless printing, in which printing is carried out by ejecting ink toward an edge of the medium from said ink ejecting section, is stored on a memory; and
wherein when said borderless printing is executed, said execution history stored on said memory is checked, and if said borderless printing has not been executed before, then said threshold value is changed based on said signal that is output from said optical sensor when light is emitted from said light-emitting section toward said support member and the light that is reflected by said support member is received by said light-receiving section.

17. A method of detecting a medium, comprising the steps of:
emitting light from a light-emitting section of an optical sensor toward a support member for supporting a medium, said support member being provided with an ink collecting section for collecting ink that has been ejected from an ink ejecting section and that has landed outside of said medium;
changing a threshold value based on a signal that is output from said optical sensor in correspondence with an intensity of light reflected by said support member and received by a light-receiving section of said optical sensor; and
detecting the medium by comparing the signal that is output from said optical sensor and the threshold value that has been changed.

18. A computer-readable storage medium having recorded thereon a program,
wherein said program causes a printing apparatus provided with:
an ink ejecting section that ejects ink onto a medium to perform printing;
a support member that supports said medium being printed by said ink ejecting section;
an ink collecting section that is provided in said support member and that collects ink that has been ejected from said ink ejecting section and landed outside of said medium; and
an optical sensor that is provided in opposition to said support member, that has a light-emitting section that emits light and a light-receiving section that receives light, and that outputs a signal that corresponds to an intensity of the light received by said light-receiving section;
said printing apparatus being configured to detect said medium by comparing said signal that is output from said optical sensor and a threshold value;
to execute the steps of:
obtaining the signal that is output from said optical sensor when light is emitted from said light-emitting section toward said support member and the light that is reflected by said support member is received by said light-receiving section; and
changing said threshold value based on said signal that has been obtained.

19. A printing apparatus comprising:
an ink ejecting section that ejects ink onto a medium to perform printing;
a support member that supports said medium being printed by said ink ejecting section;
an ink collecting section that is provided in said support member and that collects ink that has been ejected from said ink ejecting section and landed outside of said medium; and
an optical sensor that is provided in opposition to said support member, that has a light-emitting section that emits light and a light-receiving section that receives light, and that outputs a signal that corresponds to an intensity of the light received by said light-receiving section;
wherein said medium is detected by comparing said signal that is output from said optical sensor and a threshold value; and
wherein said threshold value is changed based on the signal that is output from said optical sensor when light is emitted from said light-emitting section toward said support member and the light that is reflected by said support member is received by said light-receiving section.

20. A printing method comprising the steps of:
when inspecting a condition of a supporting section that supports a medium being printed by a printing section, changing a threshold value based on a value that is obtained by sampling, at a different period from a predetermined period, a signal that is generated by an optical sensor in correspondence with an intensity of light emitted onto said supporting section from a light-emitting section of said optical sensor and reflected by said supporting section and received by a light-receiving section of said optical sensor when said optical sensor is moved relative to said supporting section; and
when performing printing, detecting the medium by comparing the threshold value that has been changed and a value that is obtained by sampling, at said predetermined period, the signal that is generated by said optical sensor when said optical sensor is moved relative to said supporting section.

21. A printing method according to claim 20,
wherein the period for said sampling that is executed when inspecting the condition of said supporting section is shorter than the period for said sampling that is executed when performing printing.

22. A printing method according to claim 20,
wherein a same controller performs said sampling that is executed when inspecting the condition of said supporting section and said sampling that is executed when performing printing.

23. A printing method according to claim 20,
wherein a movement velocity when said optical sensor is moved relative to said supporting section during printing is different from a movement velocity when said optical sensor is moved relative to said supporting section during inspection of the condition of said supporting section.

24. A printing method according to claim 23,
wherein the movement velocity when said optical sensor is moved relative to said supporting section during inspection of the condition of said supporting section is faster than the movement velocity when said optical sensor is moved relative to said supporting section during printing.

25. A printing method according to claim 20,
wherein a range over which said optical sensor moves relative to said supporting section when changing said threshold value spans over the entire supporting section.

26. A printing method according to claim 20,
wherein a range over which said optical sensor moves relative to said supporting section when changing said threshold value is equal to a range over which said optical sensor moves relative to said supporting section when detecting said medium.

27. A printing method according to claim 20,
wherein a minimum value or a maximum value is obtained from said signal that is output from said optical sensor, and said threshold value is changed based on said minimum value or said maximum value.

28. A printing method according to claim 27,
wherein said threshold value is not changed when said minimum value or said maximum value does not reach a predetermined reference value.

29. A printing method according to claim 20,
wherein the condition of said supporting section is inspected when printing is not being performed with respect to said medium by said printing section.

30. A printing method according to claim 20,
wherein said printing section, said supporting section, and said optical sensor are provided in a printing apparatus; and
wherein the condition of said supporting section is inspected when power of said printing apparatus is turned on.

31. A printing method according to claim 20,
wherein an execution history of borderless printing, in which printing is carried out by ejecting ink toward an edge of the medium from said printing section, is stored on a memory; and
wherein when said borderless printing is executed, said execution history stored on said memory is checked, and if said borderless printing has not been executed before, then said threshold value is changed based on said signal that is output from said optical sensor when light is emitted from said light-emitting section toward said supporting section and the light that is reflected by said supporting section is received by said light-receiving section.

32. A printing method according to claim 20,
wherein said printing section performs printing by ejecting ink toward said medium.

33. A printing method comprising the steps of:
when inspecting a condition of a supporting section that supports a medium being printed by a printing section, changing a threshold value based on a value that is obtained by sampling, at a period that is shorter than a predetermined period, a signal that is generated by an optical sensor in correspondence with an intensity of light emitted onto said supporting section from a light-emitting section of said optical sensor and reflected by said supporting section and received by a light-receiving section of said optical sensor when said optical sensor is moved relative to said supporting section; and
when performing printing, detecting the medium by comparing the threshold value that has been changed and a value that is obtained by sampling, at said predetermined period, the signal that is generated by said optical sensor when said optical sensor is moved relative to said supporting section;
wherein a same controller performs said sampling that is executed when inspecting the condition of said supporting section and said sampling that is executed when performing printing;
wherein a movement velocity when said optical sensor is moved relative to said supporting section during inspection of the condition of said supporting section is faster than a movement velocity when said optical sensor is moved relative to said supporting section during printing;
wherein a range over which said optical sensor moves relative to said supporting section when changing said threshold value spans over the entire supporting section;
wherein a range over which said optical sensor moves relative to said supporting section when changing said threshold value is equal to a range over which said optical sensor moves relative to said supporting section when detecting said medium;
wherein a minimum value or a maximum value is obtained from said signal that is output from said optical sensor, and said threshold value is changed based on said minimum value or said maximum value;
wherein said threshold value is not changed when said minimum value or said maximum value does not reach a predetermined reference value;
wherein said printing section, said supporting section, and said optical sensor are provided in a printing apparatus;
wherein the condition of said supporting section is inspected when printing is not being performed with respect to said medium by said printing section and when power of said printing apparatus is turned on;
wherein an execution history of borderless printing, in which printing is carried out by ejecting ink toward an edge of the medium from said printing section, is stored on a memory;
wherein when said borderless printing is executed, said execution history stored on said memory is checked, and if said borderless printing has not been executed before, then said threshold value is changed based on said signal that is output from said optical sensor when light is emitted from said light-emitting section toward said supporting section and the light that is reflected by said supporting section is received by said light-receiving section; and
wherein said printing section performs printing by ejecting ink toward said medium.

34. A method of detecting a medium, comprising the steps of:
when inspecting a condition of a supporting section that supports a medium being printed by a printing section, changing a threshold value based on a value that is obtained by sampling, at a different period from a predetermined period, a signal that is generated by an optical sensor in correspondence with an intensity of light emitted onto said supporting section from a light-emitting section of said optical sensor and reflected by said supporting section and received by a light-receiving section of said optical sensor when said optical sensor is moved relative to said supporting section; and
when performing printing, detecting the medium by comparing the threshold value that has been changed and a value that is obtained by sampling, at said predetermined period, the signal that is generated by said optical sensor when said optical sensor is moved relative to said supporting section.

35. A computer-readable storage medium having recorded thereon a program,
wherein said program causes a printing apparatus provided with:
a printing section that performs printing with respect to a medium;
a supporting section that supports the medium being printed by said printing section; and
an optical sensor that is provided in opposition to said supporting section, that is movable relative to said supporting section, that has a light-emitting section that emits light and a light-receiving section that receives light, and that generates a signal that corresponds to an intensity of the light received by said light-receiving section;
said printing apparatus being configured to detect, when performing printing, said medium by comparing a threshold value and a value that is obtained by sampling, at a predetermined period, said signal that is generated by said optical sensor when said optical sensor is moved relative to said supporting section;
to execute the steps of:
when inspecting a condition of said supporting section, sampling, at a different period from said predetermined period, the signal that is generated by said optical sensor when said optical sensor is moved relative to said supporting section; and
changing said threshold value based on a value that is obtained through said sampling.

36. A printing apparatus comprising:
a printing section that performs printing with respect to a medium;
a supporting section that supports the medium being printed by said printing section; and
an optical sensor that is provided in opposition to said supporting section, that is movable relative to said supporting section, that has a light-emitting section that emits light and a light-receiving section that receives light, and that generates a signal that corresponds to an intensity of the light received by said light-receiving section;
wherein when performing printing, said medium is detected by comparing a threshold value and a value that is obtained by sampling, at a predetermined period, said signal that is generated by said optical sensor when said optical sensor is moved relative to said supporting section; and
wherein when inspecting a condition of said supporting section, said threshold value is changed based on a value that is obtained by sampling, at a different period from said predetermined period, said signal that is generated by said optical sensor when said optical sensor is moved relative to said supporting section.
